(19) United States
(12) Patent Application Publication
(10) Pub. No.: US 2012/0236746 A1
(43) Pub. Date: Sep. 20, 2012

(54) BASE STATION APPARATUS AND TERMINAL APPARATUS FOR TRANSMITTING OR RECEIVING A SIGNAL INCLUDING PREDETERMINED INFORMATION

(75) Inventors: Makoto NAGAI, Kakamigahara City (JP); Yuichi Kanai, Ichinomiya City (JP)

(73) Assignees: PRIMEWORKS IP ATTORNEYS, Tokyo (JP); SANYO ELECTRIC CO., LTD, Osaka (JP)

(21) Appl. No.: 13/425,202

(22) Filed: Mar. 20, 2012

Related U.S. Application Data
(63) Continuation of application No. PCT/JP2011/002777, filed on May 18, 2011.

(30) Foreign Application Priority Data
May 19, 2010 (JP) 2010-115830
May 19, 2010 (JP) 2010-115831
Jul. 30, 2010 (JP) 2010-172184

(51) Int. Cl. H04W 24/00; H04J 3/00; H04W 88/02; H04W 88/00

(52) U.S. Cl. 370/252

(57) ABSTRACT

An acquiring unit receives a packet signal of a first type from the other base station apparatus. A measuring unit measures a receipt frequency of the packet signal of the first type which is received. A determining unit determines a timing for broadcasting a packet signal of a second type to inform a terminal apparatus of a presence based on the receipt frequency which is measured and a receipt timing of the packet signal of the first type which is received. A broadcasting unit broadcasts the packet signal of the second type in the determined timing. A communicating unit executes a communication with the terminal apparatus receiving the packet signal of the second type.

### BACKGROUND OF THE INVENTION

1. Field of the Invention

The present invention relates to a communication technique and more particularly to a base station apparatus and a terminal apparatus which transmit/receive a signal including predetermined information.

2. Description of the Related Art

In order to prevent a collision accident in a passage through an intersection, a road-to-vehicle communication is carried out. In the road-to-vehicle communication, information about a situation of the intersection is caused to communicate between a road side machine and an in-vehicle apparatus. In the road-to-vehicle communication, it is necessary to dispose the road side machine so that a time and labor and a cost are increased. On the other hand, in a configuration in which the information is caused to communicate in the communication between cars, that is, in-vehicle apparatuses, the road side machine does not need to be provided. In that case, for example, current position information is detected in real time by means of a GPS (Global Positioning System) or the like and is exchanged mutually between the in-vehicle apparatuses to determine in which road a self vehicle and other vehicles each entering the intersection are positioned.

Moreover, it is demanded for a plurality of terminal apparatuses sharing a transmission path to equalize an opportunity for transmitting data without reducing a throughput of the transmission path. For this purpose, the base station apparatus counts the visiting number of the terminal apparatus in a service area.

Moreover, a back-off time taken for enabling a transmission of a next frame after each of the terminal apparatuses transmits a frame to the base station apparatus is determined depending on the visiting number thus counted.

In a wireless LAN (Local Area Network) in accordance with the standards such as IEEE802.11, an access control function referred to as a CSMA/CA (Carrier Sense Multiple Access with Collision Avoidance) is used. For this reason, in the wireless LAN, the same wireless channel is shared by the terminal apparatuses. In the CSMA/CA, it is confirmed that another packet signal is not transmitted through a carrier sense and a packet signal is then transmitted.

On the other hand, in the case in which the wireless LAN is applied to an inter-vehicle communication such as ITS (Intelligent Transport Systems), it is necessary to transmit information to a large number of unspecified terminal apparatuses. For this reason, it is desirable that the signal should be broadcasted. However, an increase in the number of the vehicles, that is, an increase in the number of terminal apparatuses increases a traffic so that an increase in collisions of the packet signal is supposed in the intersection or the like. As a result, data included in the packet signal is not transmitted to the other terminal apparatuses. If such a state is generated in the inter-vehicle communication, it is impossible to achieve an object for preventing a collision accident in a passage through the intersection. If the road-to-vehicle communication is executed in addition to inter-vehicle communication, furthermore, a communication configuration is made various. In that case, it is demanded to reduce a mutual influence between the inter-vehicle communication and the road-to-vehicle communication.

In addition to the communication for preventing the collision accident of the vehicles, moreover, it is also demanded to execute an IP (Internet Protocol) communication such as an access to Internet. In that case, the terminal apparatus is connected to a base station apparatus capable of accessing the Internet. In consideration of an original object for the communication system, it is apparent that importance of the IP communication is lower than that of a communication for preventing the collision accident of the vehicle. For this reason, it is also demanded to reduce a mutual influence between both of the communications.

### SUMMARY OF THE INVENTION

The present invention addresses the challenge and a purpose thereof is to provide a technique for reducing a mutual influence between a plurality of target communications.

In order to solve the problems, an aspect of the present invention is directed to a base station apparatus for communicating with a terminal apparatus. The base station apparatus includes: a receiving unit configured to receive a packet signal of a first type, wherein the other base station apparatus broadcasts the packet signal of the first type for controlling an inter-terminal communication for a partial period of at least one subframe in a frame multiplexing the subframes in time, and the inter-terminal communication is carried out by the terminal apparatus receiving the packet signal of the first type for a non-broadcasting period of the packet signal of the first type in the frame; a measuring unit configured to measure a receipt frequency of the packet signal of the first type which is received by the receiving unit; a determining unit configured to determine a timing to broadcast a packet signal of a second type in order to inform the terminal apparatus of a presence based on the receipt frequency measured by the measuring unit and a receipt timing of the packet signal of the first type which is received by the receiving unit; a broadcasting unit configured to broadcast the packet signal of the second type in the timing determined by the determining unit; and a communicating unit configured to execute a communication with the terminal apparatus receiving the packet signal of the second type from the broadcasting unit.

Another aspect of the present invention is directed to a terminal apparatus. The apparatus includes: an acquiring unit configured to acquire a duration of a first period based on information about the duration of the first period included in the packet signal of the first type broadcasted for the first period in a frame in which the first period for which a base station broadcasts the packet signal of the first type and a second period for which the terminal apparatus broadcasts a packet signal of a second type are multiplexed in time; a counting unit configured to count a number of the packet signals of the second type having a certain length broadcasted for the second period; a deriving unit configured to derive a period in which the packet signal of the second type is broadcasted for the second period based on the number of the packet signals of the second type which is counted by the counting unit and a period for the packet signal of the second type; a measuring unit configured to measure a period in which a packet signal of a third type having a variable length is transmitted; and an estimating unit configured to integrate the period measured by the measuring unit, the period derived by the deriving unit and the duration of the first period acquired by the acquiring unit and to then estimate a frame free time rate based on an integrated value and a period of the frame, and to estimate a frame utilization rate based on the period derived by the driving unit and the duration of the first period acquired by the acquiring unit.

The any combination of the components, and the expressions of the present invention which are obtained by making a conversion in a method, an apparatus, a system, a recording medium, a computer program and the like are effective for the aspects of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view showing a structure of a communication system according to an embodiment of the present invention;

FIG. 2 is a diagram showing a structure of a base station apparatus in FIG. 1;

FIGS. 3(a) to 3(d) are diagrams showing a format defined in the communication system of FIG. 1;

FIGS. 4(a) and 4(b) are diagrams showing a structure of a subframe in FIGS. 3(a) to 3(d);

FIGS. 5(a) to 5(c) are diagrams showing a format of an MAC frame stored in a packet signal defined in the communication system of FIG. 1;

FIG. 6 is a diagram showing a structure of an IP communicating base station apparatus in FIG. 1;

FIG. 7 is a diagram showing a data structure of a table stored in a determining unit of FIG. 6;

FIGS. 8(a) to 8(d) are diagrams showing a summary of a processing for broadcasting a beacon signal by the IP communicating base station apparatus in FIG. 6;

FIG. 9 is a diagram showing a structure of a terminal apparatus mounted on a vehicle in FIG. 1;

FIG. 10 is a flow chart showing a procedure for determining a broadcasting timing by the IP communicating base station apparatus in FIG. 6;

FIG. 11 is a flowchart showing a procedure for broadcasting a beacon signal by the IP communicating base station apparatus in FIG. 6;

FIG. 12 is a diagram showing a structure of a base station apparatus according to a modified example of the present invention;

FIG. 13 is a diagram showing a structure of the IP communicating base station apparatus in FIG. 1 according to another modified example of the present invention;

FIG. 14 is a diagram showing a data structure of a table stored in a storing unit of FIG. 13;

FIG. 15 is a diagram showing a data structure of another table stored in the storing unit of FIG. 13;

FIG. 16 is a diagram showing a structure of a terminal apparatus mounted on the vehicle in FIG. 1;

FIG. 17 is a diagram showing a data structure of a table stored in a storing unit of FIG. 16;

FIG. 18 is a flow chart showing a procedure for controlling a transmission timing in the terminal apparatus of FIG. 16; and

FIG. 19 is a diagram showing a structure of a base station apparatus according to a further modified example of the present invention.

### DETAILED DESCRIPTION OF THE INVENTION

The invention will now be described by reference to the preferred embodiments. This does not intend to limit the scope of the present invention, but to exemplify the invention.

Before a specific explanation of the present invention, summary will be described. An embodiment according to the present invention relates to a communication system for executing an inter-vehicle communication in a terminal apparatus mounted on a vehicle, and furthermore, a road-vehicle communication from a base station apparatus disposed on an intersection or the like to the terminal apparatus. As the inter-vehicle communication, the terminal apparatus broadcasts a packet signal storing information about a speed and a position of a vehicle and the like (which will be hereinafter referred to as “data”). Moreover, another terminal apparatus receives the packet signal and recognizes an approach of the vehicle based on the data. The base station apparatus repetitively defines a frame including a plurality of subframes. The base station apparatus selects any of the subframes and broadcasts the packet signal storing control information and the like for a period of a head portion of the selected subframe in order to perform a road-to-vehicle communication.

The control information includes information about a period for which the base station apparatus broadcasts the packet signal (hereinafter referred to as a “road-to-vehicle transmission period”). The terminal apparatus specifies the road-to-vehicle transmission period based on the control information and transmits the packet signal for a period other than the road-to-vehicle transmission period. Thus, the road-to-vehicle communication and the inter-vehicle communication are subjected to time-division multiplexing. Therefore, a collision probability of the packet signals between both of them can be reduced. In other words, it is possible to reduce an interference between the road-to-vehicle communication and the inter-vehicle communication by recognizing the contents of the control information by the terminal apparatus. Moreover, an area in which the terminal apparatus executing the inter-vehicle communication is present is mainly classified into three types.

A first one of them is an area formed around the base station apparatus (which will be hereinafter referred to as a “first area”), a second one is an area formed on an outside of the first area (which will be hereinafter referred to as a “second area”), and a third one is an area formed on an outside of the second area (which will be hereinafter referred to as an “area outside the second area”). While the terminal apparatus can receive the packet signal of some quality from the base station apparatus in the first and second areas, the terminal apparatus cannot receive the packet signal of some quality from the base station apparatus in the area outside the second area. Moreover, the first area is formed to approach a center of an intersection more greatly than the second area. A vehicle present in the first area is close to the intersection. For this reason, it is apparent that the packet signal transmitted from the terminal apparatus mounted on the vehicle is important information in respect of a suppression in a collision accident.

Corresponding to the regulations of the areas, a period for the inter-vehicle communication (which will be hereinafter referred to as a “inter-vehicle transmission period”) is formed by the time-division multiplexing of a priority period and a general period. The priority period indicates a period to be used by the terminal apparatus present in the first area, and the terminal apparatus transmits the packet signal in any of slots forming the priority period. Moreover, the general period indicates a period to be used by the terminal apparatus present in the second area, and the terminal apparatus transmits the packet signal by a CSMA scheme for the general period. The terminal apparatus which is present on the outside of the second area transmits the packet signal by the CSMA scheme irrespective of a structure of a frame. Herein, it is determined in which area the terminal apparatus mounted on a vehicle is present. Depending on the base station apparatus, the first area is not formed in some cases. In those cases, an inter-vehicle transmission period does not include the priority period but is formed by only the general period.

If the terminal apparatus can execute the IP communication in addition to the inter-vehicle communication, a utilization efficiency of a frequency can be enhanced, and furthermore, a convenience for a user can be improved. A base station apparatus for executing the IP communication (which will be hereinafter referred to as an “IP communicating base station apparatus”) is provided separately from the base station apparatus described above. The IP communicating base station apparatus broadcasts a beacon signal and executes a communication with a terminal apparatus receiving the beacon signal in the same manner as in a normal wireless LAN base station apparatus. An identical frequency band is used for the IP communication and the inter-vehicle communication. For this reason, the IP communication is required not to prevent the inter-vehicle communication. This is because, since the inter-vehicle communication is carried out to suppress an occurrence of a collision accident of vehicles, it is apparent that the inter-vehicle communication has a higher priority than the IP communication. In order to take a countermeasure, the IP communicating base station apparatus measures a frequency of a receipt of the packet signal from the base station apparatus. Moreover, the IP communicating base station apparatus determines a broadcasting frequency of the beacon signal depending on the receipt frequency.

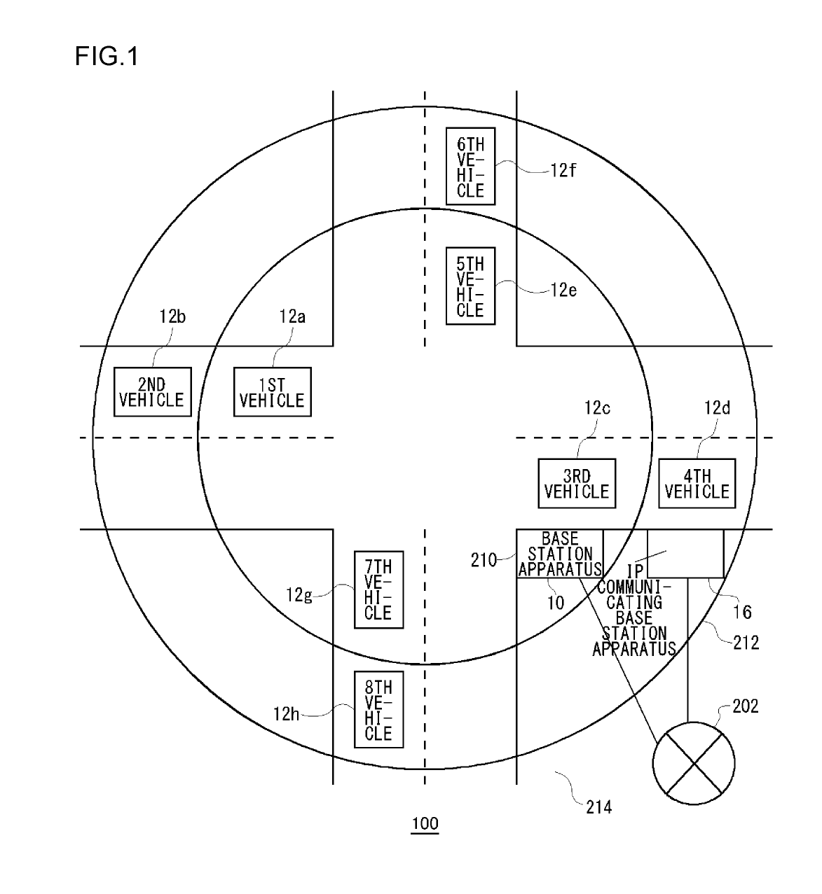

FIG. 1 shows a structure of a communication system 100 according to an embodiment of the present embodiment. This corresponds to the case in which a single intersection is seen from above. The communication system 100 includes a base station apparatus 10, an IP communicating base station apparatus 16, a first vehicle 12a, a second vehicle 12b, a third vehicle 12c, a fourth vehicle 12d, a fifth vehicle 12e, a sixth vehicle 12f, a seventh vehicle 12g and an eighth vehicle 12h which are generally referred to as a vehicle 12, and a network 202. A terminal apparatus which is not shown is mounted on each vehicle 12. Moreover, a first area 210 is formed around the base station apparatus 10, a second area 212 is formed on an outside of the first area 210, and an area outside the second area 214 is formed on an outside of the second area 212.

As shown, a road in a horizontal direction of the drawing, that is, a transverse direction and a road in a perpendicular direction of the drawing, that is, a vertical direction intersect with each other in a central part. In the drawing, an upper side corresponds to “north” of a direction, a left side corresponds to “west” of the direction, a lower side corresponds to “south” of the direction, and a right side corresponds to “east” of the direction. Moreover intersecting portion of two roads indicates an “intersection”. The first vehicle 12a and the second vehicle 12b advance from left toward right, and the third vehicle 12c and the fourth vehicle 12d advance from right toward left. Moreover, the fifth vehicle 12e and the sixth vehicle 12f advance from top toward bottom, and the seventh vehicle 12g and the eighth vehicle 12h advance from bottom toward top.

The communication system 100 disposes the base station apparatus 10 on the intersection. The base station apparatus 10 controls a communication between terminal apparatuses. The base station apparatus 10 repetitively generates a frame including a plurality of subframes based on a signal received from a GPS satellite which is not shown or a frame formed by another base station apparatus 10 which is not shown. Therein, it is defined that the road-to-vehicle transmission period can be set to a head portion of each subframe. The base station apparatus 10 selects any of the subframes to which the road-to-vehicle transmission period is not set by another base station apparatus 10. The base station apparatus 10 sets the road-to-vehicle transmission period to the head portion of the subframe thus selected. The base station apparatus 10 broadcasts the packet signal for the road-to-vehicle transmission period thus set.

As data to be included in the packet signal, plural types of data are assumed. One of them is data such as traffic jam information, construction information and the like, the other is data on each slot included in the priority period. The latter includes a slot which is not used in any of the terminal apparatuses (which will be hereinafter referred to as an “empty slot”), a slot used in one of the terminal apparatuses (which will be hereinafter referred to as a “used slot”), and a slot used in the terminal apparatuses (which will be hereinafter referred to as a “collision slot”). A packet signal including data on the traffic jam information, the construction information and the like (which will be hereinafter referred to as an “RSU packet signal”) and a packet signal including data on each slot (which will be hereinafter referred to as a “control packet signal”) are generated separately. The RSU packet signal and the control packet signal are generally referred to as the “packet signal”.

Depending on a receiving situation in which the terminal apparatus receives the packet signal from the base station apparatus 10, the first area 210 and the second area 212 are formed around the communication system 100. As shown in the drawing, the first area 210 is formed as a region having a comparatively good receiving situation close to the base station apparatus 10. It is apparent that the first area 210 is formed close to the central part of the intersection. On the other hand, the second area 212 is formed as a region in which the receiving situation is poorer than the first area 210 at the outside of the first area 210. Furthermore, the area outside the second area 214 is formed as a region in which the receiving situation is further poorer than the second area 212 at the outside of the second area 212. An error rate of the packet signal and a received power are used as the receiving situation.

The packet signal sent from the base station apparatus 10 include two types of control information, and one of them is information about the road-to-vehicle transmission period that is set (which will be hereinafter referred to as a “basic part”) and the other is information about the priority period that is set (which will be hereinafter referred to as a “extended part”). The terminal apparatus generates a frame based on the basic part included in the packet signal which is received. As a result, the frame generated in each of the terminal apparatuses is synchronized with the frame generated in the base station apparatus 10. Moreover, the terminal apparatus receives the packet signal broadcasted by the base station apparatus 10 and estimates based on the receiving situation and the extended part of the received packet signal in which area of the first area 210, the second area 212 and the area outside the second area 214 the terminal apparatus is present. In the case in which the terminal apparatus is present in the first area 210, the packet signal is broadcasted through any of the slots included in the priority period. In the case in which the terminal apparatus is present in the second area 212, the packet signal is broadcasted in a carrier sense for the general period. For this reason, TDMA is executed for the priority period and CSMA/CA is executed for the general period.

The terminal apparatus selects a subframe having an identical relative timing also in a next frame. For the priority period, particularly, the terminal apparatus selects a slot having the identical relative timing in the next frame. Herein, the terminal apparatus acquires data and stores the data in the packet signal. The data includes information about a presence position, for example. Moreover, the terminal apparatus stores the control information in the packet signal. In other words, the control information transmitted from the base station apparatus 10 is transferred to the terminal apparatus. On the other hand, in the case in which the terminal apparatus is estimated to be present in the area outside the second area 214, the terminal apparatus executes the CSMA/CA to broadcast the packet signal irrespective of the structure of the frame.

The IP communicating base station apparatus 16 uses a frequency band identical with that of the base station apparatus 10 to execute the IP communication with the terminal apparatus. As a premise of the IP communication, the IP communicating base station apparatus 16 periodically broadcasts a beacon signal. The beacon signal serves to inform the terminal apparatus of the presence of the IP communicating base station apparatus 16. The terminal apparatus receiving the beacon signal requires the IP communicating base station apparatus 16 to carry out a connection. Then, a communication between the terminal apparatus and the IP communicating base station apparatus 16 is started. As a result, the terminal apparatus accesses Internet through the IP communicating base station apparatus 16 and the network 202.

The inter-vehicle communication and the road-to-vehicle communication correspond to a broadcast transmission, while the IP communication between the IP communicating base station apparatus 16 and the terminal apparatus corresponds to a unicast transmission. In the IP communication, the CSMA/CA is executed. As described above, the IP communication is required not to prevent the inter-vehicle communication or the like. In order to take a countermeasure, the IP communicating base station apparatus 16 measures a receipt frequency of the packet signal received from the base station apparatus 10 for the road-to-vehicle transmission period. As the receipt frequency is higher, a larger number of base station apparatuses 10 are provided around the IP communicating base station apparatus 16. For this reason, the IP communicating base station apparatus 16 reduces a transmission frequency of the beacon signal as the receipt frequency is increased.

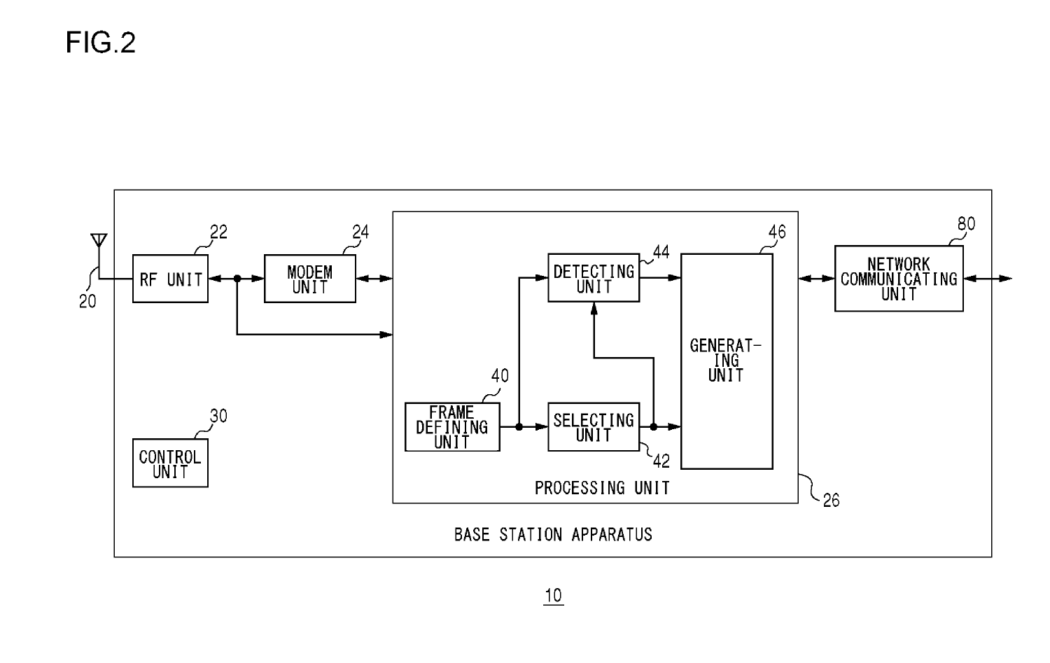

FIG. 2 shows a structure of the base station apparatus 10. The base station apparatus 10 includes an antenna 20, an RF unit 22, a modem unit 24, a processing unit 26, a control unit 30 and a network communicating unit 80. The processing unit 26 includes a frame defining unit 40, a selecting unit 42, a detecting unit 44 and a generating unit 46. The RF unit 22 receives the packet signal transmitted from the terminal apparatus or the other base station apparatus 10 which is not shown through the antenna 20 as a receipt processing. The RF unit 22 executes a frequency conversion for a packet signal having a radio frequency which is received, and generates a baseband packet signal. Furthermore, the RF unit 22 outputs the baseband packet signal to the modem unit 24. In general, the baseband packet signal is formed by an in-phase component and an quadrature component. Therefore, two signal lines are to be shown. However, only one of the signal lines is shown here in order to make the drawing clear. The RF unit 22 also includes an LNA (Low Noise Amplifier), a mixer, an AGC and an A/D converting unit.

The RF unit 22 executes the frequency conversion over the baseband packet signal input from the modem unit 24 as a transmission processing, and generates a packet signal having a radio frequency. Furthermore, the RF unit 22 transmits the packet signal having the radio frequency from the antenna 20 for the road-to-vehicle transmission period. Moreover, the RF unit 22 also includes a PA (Power Amplifier), a mixer and a D/A converting unit.

The modem unit 24 executes a demodulation for the baseband packet signal transmitted from the RF unit 22 as a receipt processing. Furthermore, the modem unit 24 outputs a result of the demodulation to the processing unit 26. In addition, the modem unit 24 executes a modulation for the data sent from the processing unit 26 as a transmission processing. In addition, the modem unit 24 outputs a result of the modulation as a baseband packet signal to the RF unit 22. Herein, the communication system 100 corresponds to an OFDM (Orthogonal Frequency Division Multiplexing) modulating method. Therefore, the modem unit 24 also executes FFT (Fast Fourier Transform) as the receipt processing and IFFT (Inverse Fast Fourier Transform) as the transmission processing.

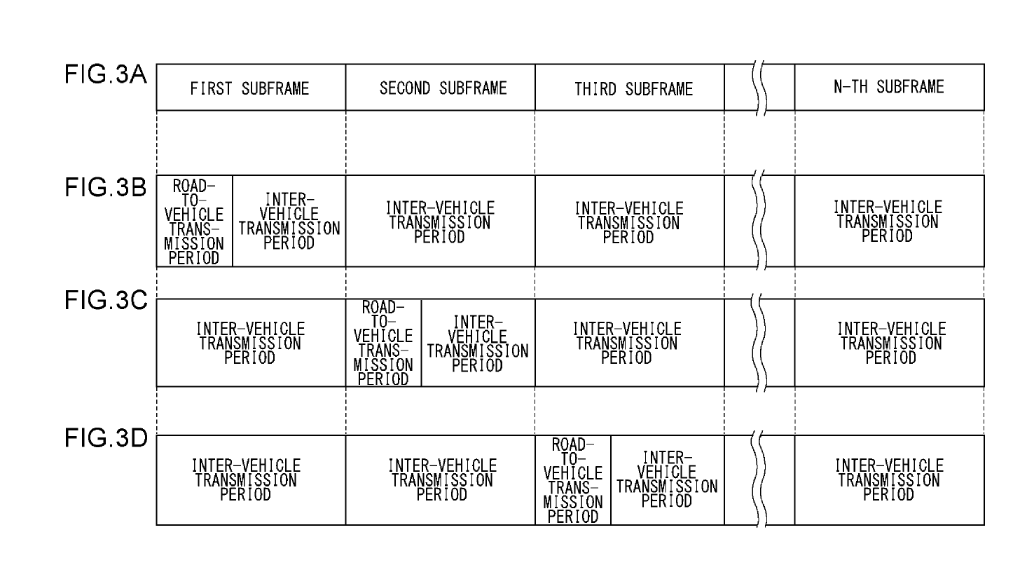

The frame defining unit 40 receives a signal from the GPS satellite (not shown) and acquires information about a time based on the received signal. It is sufficient that the well-known technique is used for acquiring the information about the time. Therefore, description will be omitted. The frame defining unit 40 generates a plurality of frames based on the information about the time. For example, the frame defining unit 40 divides a period of “1 sec” into 10 parts based on a timing indicated by the information about the time, thereby generating 10 frames of “100 msec”. By repeating the processing, the frame is defined to be repeated. The frame defining unit 40 may detect control information from the result of the demodulation, thereby generating a frame based on the control information thus detected. The processing corresponds to a generation of a frame which is synchronized with a timing of a frame formed by the other base station apparatus 10. FIGS. 3(a) to 3(d) show a format of a frame to be defined in the communication system 100. FIG. 3(a) shows a structure of the frame. The frame is formed by N subframes indicated as a first subframe to an N-th subframe. For example, in the case in which the frame has a length of 100 msec and N is eight, a subframe having a length of 12.5 msec is defined. FIGS. 3(b) to 3(d) will be described below and FIG. 2 will be referenced again.

The selecting unit 42 selects any of the subframes included in the frame to which the road-to-vehicle transmission period is to be set. More specifically, the selecting unit 42 accepts the frame defined in the frame defining unit 40. The selecting unit 42 inputs the result of the demodulation from the other base station apparatus 10 or the terminal apparatus which is not shown through the RF unit 22 and the modem unit 24. The selecting unit 42 extracts the result of the demodulation from the other base station apparatus 10 in the result of the demodulation thus input. The extraction method will be described later. The selecting unit 42 specifies the subframe accepting the result of the demodulation, thereby specifying the subframe which does not accept the result of the demodulation. This corresponds to that the subframe to which the road-to-vehicle transmission period is not set by the other base station apparatus 10, that is, an unused subframe. In the case in which a plurality of unused subframes is present, the selecting unit 42 selects one of the subframes randomly. In the case in which the unused subframe is not present, that is, each of the subframes is used, the selecting unit 42 acquires a received power corresponding to the result of the demodulation and preferentially selects a subframe having a small received power.

FIG. 3(b) shows a structure of a frame generated by the first base station apparatus 10a. The first base station apparatus 10a sets the road-to-vehicle transmission period to the head portion of the first subframe. Moreover, the first base station apparatus 10a sets the inter-vehicle transmission period after the road-to-vehicle transmission period in the first subframe. The inter-vehicle transmission period indicates a period in which the terminal apparatus can broadcast the packet signal. In other words, the first base station apparatus 10a is regulated to be able to broadcast the packet signal for the road-to-vehicle transmission period to be the head period of the first subframe, and the terminal apparatus is regulated to be able to broadcast the packet signal for the inter-vehicle transmission period other than the road-to-vehicle transmission period in the frames. Furthermore, the first base station apparatus 10a sets only the inter-vehicle transmission period from the second subframe to the N-th subframe.

FIG. 3(c) shows a structure of a frame generated by the second base station apparatus 10b. The second base station apparatus 10b sets a road-to-vehicle transmission period in the head portion of the second subframe. Moreover, the second base station apparatus 10b sets an inter-vehicle transmission period from the first subframe and the third subframe to the N-th subframe in a second stage of the road-to-vehicle transmission period in the second subframe. FIG. 3(d) shows a structure of a frame generated by the third base station apparatus 10c. The third base station apparatus 10c sets the road-to-vehicle transmission period to the head portion of the third subframe. Moreover, the third base station apparatus 10c sets the inter-vehicle transmission period from the first subframe, the second subframe and the fourth subframe to the N-th subframe in the second stage of the road-to-vehicle transmission period in the third subframe. Thus, a plurality of base station apparatuses 10 selects the subframes which are different from each other, and sets the road-to-vehicle transmission period to the head portion of the subframe thus selected. FIG. 2 will be referenced again. The selecting unit 42 outputs the number of the selected subframe to the detecting unit 44 and the generating unit 46.

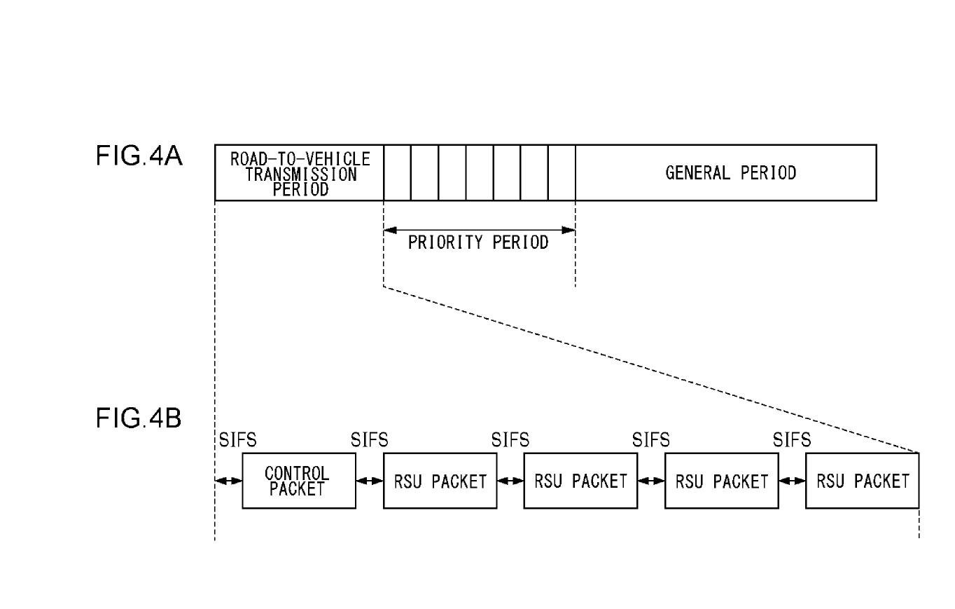

The detecting unit 44 specifies whether each of the slots included in the priority period is unused or is being used or a collision occurs. Before the explanation of the processing of the detecting unit 44, description will be given to the structure of the subframe. FIGS. 4(a) and 4(b) show the structure of the subframe. As shown in the drawings, a single subframe is constituted in order of the road-to-vehicle transmission period, the priority period and the general period. The base station apparatus 10 broadcasts the packet signal for the road-to-vehicle transmission period, the priority period is formed in time division multiplexing for the slots, the terminal apparatus 14 can broadcast the packet signal through each of the slots, the general period has a predetermined length, and the terminal apparatus 14 can broadcast the packet signal. The priority period and the general period correspond to the inter-vehicle transmission period in FIG. 3(b) or the like. In the case in which the road-to-vehicle transmission period is not included in the subframe, the subframe is constituted in order of the prior period and the general period. In that case, the road-to-vehicle transmission period is also equivalent to the priority period. Herein, the general period is also formed in the time division multiplexing of the slots. Description will be given later with reference to FIG. 4(b). FIG. 2 will be referenced again.

The detecting unit 44 measures a received power for each of the slots and also measures an error rate for each of the slots. An example of the error rate is BER (Bit Error Rate). If the received power is smaller than a threshold for the received power, the detecting unit 44 determines that the slot is unused (the slot will be hereinafter referred to as an “empty slot”). On the other hand, if the received power is equal to or greater than the threshold for the received power and the error rate is lower than a threshold for the error rate, the detecting unit 44 determines that the slot is being used (the slot will be hereinafter referred to as an “used slot”). If the received power is equal to or greater than the threshold for the received power and the error rate is equal to or greater than a threshold for the error rate, the detecting unit 44 determines that the collision occurs in the slot (the slot will be hereinafter referred to as a “collision slot”). The detecting unit 44 executes the processing for all of the slots and outputs their result (which will be hereinafter referred to as a “detection result”) to the generating unit 46.

The generating unit 46 accepts the number of the subframe from the selecting unit 42 and accepts the detection result from the detecting unit 44. The generating unit 46 sets the road-to-vehicle transmission period to the subframe having the subframe number thus accepted, and generates a control packet signal and an RSU packet signal which are to be broadcasted for the road-to-vehicle transmission period. FIG. 4(b) shows an arrangement of the packet signal for the road-to-vehicle transmission period. As shown in the drawing, a single control packet signal and a plurality of RSU packet signals are arranged for the road-to-vehicle transmission period. The vertical packet signals are provided apart from each other by SIFS (Short Interframe Space). FIG. 2 will be referenced again.

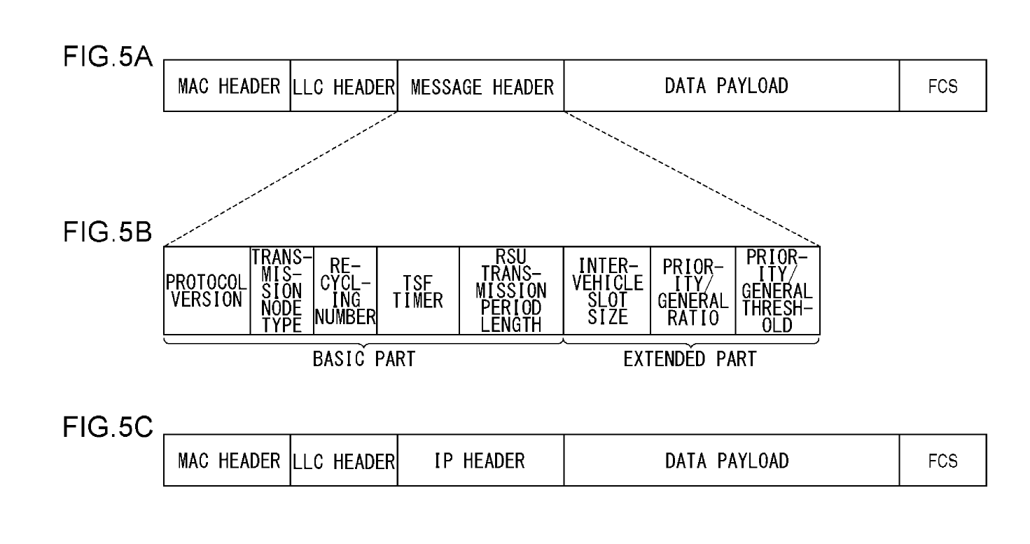

Description will be given to structures of the control packet signal and the RSU packet signal. FIGS. 5(a) to 5(c) show a format of an MAC frame stored in the packet signal defined in the communication system 100. FIG. 5(a) shows the format of the MAC frame. The MAC frame arranges “MAC header”, “LLC header”, “message header”, “data payload”, and “FCS” in order from a head. In the case in which the detection result is included in the data payload, the packet signal storing the MAC frame corresponds to the control packet signal. In the case in which the generating unit 46 accepts the data on the traffic jam information, the construction information and the like are accepted from the network communicating unit 80, it includes them in the data payload. The packet signal storing the MAC frame corresponds to the RSU packet signal. Herein, the network communicating unit 80 is connected to the network 202 which is not shown. Moreover, the packet signal broadcasted for the priority period and the general period is also stored in the MAC frame shown in FIG. 5(a).

FIG. 5(b) is a diagram showing a structure of a message header generated by the generating unit 46. The message header includes a basic part and an extended part. As described above, the structures of the control packet signal and the RSU packet signal are identical to each other. Therefore, both of the control packet signal and the RSU packet signal have the basic part and the extended part. The basic part includes “protocol version”, “transmission node type”, recycling number”, “TSF timer” and “RSU transmission period length”, and the extended part includes “inter-vehicle slot size”, “priority general ratio” and “priority general threshold”.

The protocol version indicates a version of a protocol which corresponds. The transmission node type indicates a transmitting source of the packet signal including the MAC frame. For example, “0” indicates the terminal apparatus and “1” indicates the base station apparatus 10. In the case in which the selecting unit 42 extracts any of the input demodulation results which is sent from the other base station apparatus 10, the selecting unit 42 utilizes a value of the transmission node type. The recycling number indicates an index of an effectiveness in the case in which the message header is transferred by the terminal apparatus, and the TSF timer indicates a transmission time. The RSU transmission period length indicates a length of the road-to-vehicle transmission period, and is supposed to be information about the road-to-vehicle transmission period. The inter-vehicle slot size indicates a size of the slot included in the priority period, the priority general ratio indicates a ratio of the priority period to the general period, and the priority general threshold indicates a threshold for causing the terminal apparatus 14 to select a use of the prior period or a use of the general period and a threshold for a received power. In other words, the extended part corresponds to information about the prior period and the general period. Description will be given later with reference to FIG. 5(c). FIG. 2 will be referenced again.

The processing unit 26 broadcasts a packet signal to the modem unit 24 and the RF unit 22 for the road-to-vehicle transmission period. In other words, the control packet signal including the basic part and the extended part and the RSU packet signal are broadcasted to the base station broadcasting period. The control unit 30 controls the processing of the whole base station apparatus 10.

The structure can be implemented by a CPU, a memory and other LSIs in an any computer on a hardware basis, and can be implemented by a program loaded onto a memory or the like on a software basis. Herein, a functional block implemented by their cooperation is drawn. Accordingly, the skilled in the art can understand that these functional blocks can be implemented by only the hardware, only the software or their combination.

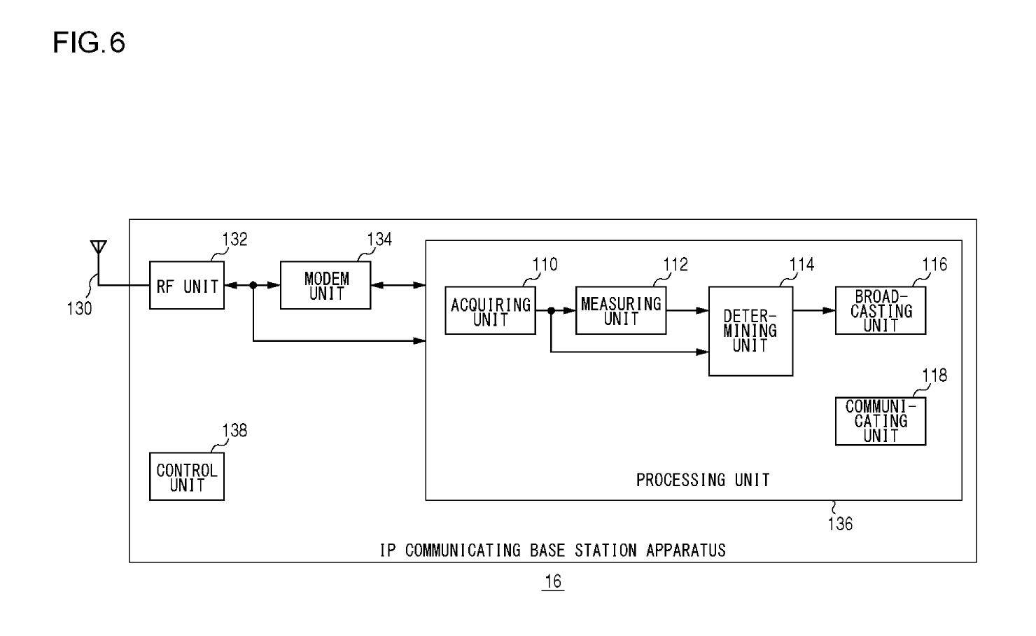

FIG. 6 shows a structure of the IP communicating base station apparatus 16. The IP communicating base station apparatus 16 includes an antenna 130, an RF unit 132, a modem unit 134, a processing unit 136 and a control unit 138. Moreover, the processing unit 136 includes an acquiring unit 110, a measuring unit 112, a determining unit 114, a broadcasting unit 116 and a communicating unit 118. The antenna 130, the RF unit 132 and the modem unit 134 execute the same processings as those of the antenna 20, the RF unit 22 and the modem unit 24 in FIG. 2. For this reason, a difference will be mainly described.

The acquiring unit 110 acquires the control packet signal or the RSU packet signal from the base station apparatus 10 (not shown) through the RF unit 132 and the modem unit 134 for the road-to-vehicle transmission period. The acquiring unit 110 generates a frame which is synchronized with the frame generated in the base station apparatus 10 (not shown) based on the control packet signal or the RSU packet signal which is thus acquired. Moreover, the acquiring unit 110 specifies any of the subframes included in the frame other than the subframe acquiring the control packet signal or the RSU packet signal.

The measuring unit 112 accepts, from the acquiring unit 110, information about a timing in which the control packet signal or the RSU packet signal is acquired. The information about the timing for the acquisition is indicated as a Y-th subframe in an X-th frame, for example. The measuring unit 112 measures the number of the subframes included in a single frame to which the road-to-vehicle transmission period is set. This corresponds to the measurement of the receipt frequency of the packet signal from the base station apparatus 10. The measuring unit 112 may derive an average value of the subframe number over the frames and may set the average value as the receipt frequency. The measuring unit 112 outputs a value of the receipt frequency to the determining unit 114.

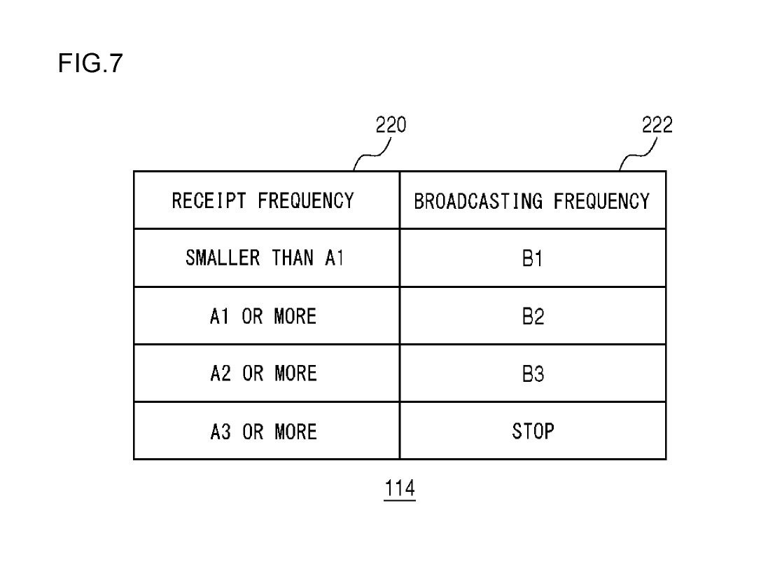

The determining unit 114 accepts, from the acquiring unit 110, information about the subframe which is specified, and accepts a value of the receipt frequency from the measuring unit 112. The determining unit 114 prestores a table in which the receipt frequency and the broadcasting frequency are caused to correspond to each other. FIG. 7 shows a data structure of the table stored in the determining unit 114. As shown, a receipt frequency column 220 and a broadcasting frequency column 222 are included. A condition for classifying the receipt frequency is shown in the receipt frequency column 220. Herein, the case in which the receipt frequency is smaller than “A1”, the case in which the receipt frequency is equal to or greater than “A1” and the case in which the receipt frequency is equal to or greater than “A3” are defined as conditions. A1<A2<A3 is assumed.

A value of the broadcasting frequency corresponding to each condition of the receipt frequency column 220 is indicated in the broadcasting frequency column 222. Herein, there are shown a broadcasting frequency of “B1”, a broadcasting frequency of “B2”, a broadcasting frequency of “B3” and a stoppage. B1>B2>B3 is set, and the stoppage corresponds to the stoppage of the broadcasting. For example, the broadcasting frequency of “B1” corresponds to twice for one frame, the broadcasting frequency of “B2” corresponds to once for one frame, and the broadcasting frequency of “B3” corresponds once for two frames. Thus, the broadcasting frequency is controlled on a subframe unit. The broadcasting frequency may be controlled on a frame unit. In that case, the broadcasting frequency has a cycle which is integer times as much as the frame. FIG. 6 will be referenced again.

With reference to the table of FIG. 7, the determining unit 114 derives the broadcasting frequency from the value of the receipt frequency which accepted. In other words, the determining unit 114 reduces a frequency for the broadcasting of the beacon signal more as the receipt frequency measured by the measuring unit 112 is higher. The determining unit 114 specifics a subframe in which the road-to-vehicle transmission period is not provided based on the information about the subframe which is specified. Furthermore, the determining unit 114 specifies a subframe reaching every broadcasting cycle in the specified subframe, thereby determining a timing in which the beacon signal is to be broadcasted. In other words, the determining unit 114 determines a timing for broadcasting the beacon signal to inform the terminal apparatus 14 of presence based on the receipt frequency measured in the measuring unit 112 and the receipt timing for the packet signal received in the acquiring unit 110. In the case in which the control packet signal or the RSU packet signal is not acquired in the acquiring unit 110, the determining unit 114 determines a broadcasting timing by setting a predetermined value as the broadcasting frequency.

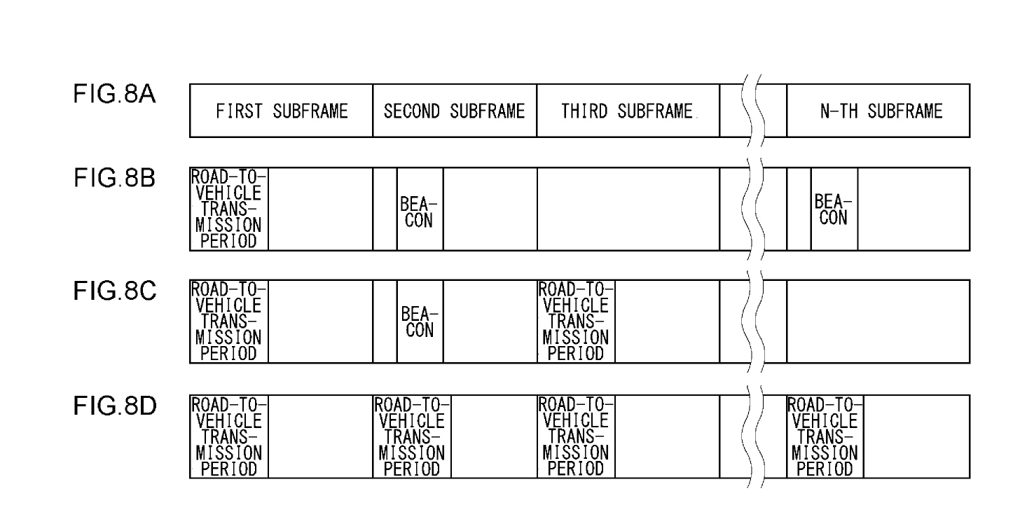

FIGS. 8(a) to 8(d) show the summary of the broadcasting processing for the beacon signal by the IP communicating base station apparatus 16. FIG. 8(a) is identical to FIG. 3(a) and illustrates a frame constituted by a plurality of subframes. In FIG. 8(b), a road-to-vehicle transmission period is set to the first subframe, and the determining unit 114 sets the broadcasting timing for the beacon signal to the second subframe and the N-th subframe. In FIG. 8(c), the road-to-vehicle transmission period is set to the first subframe and the third subframe. Therefore, the receipt frequency is increased more greatly than in FIG. 8(b). For this reason, the determining unit 114 decreases the broadcasting frequency as compared with FIG. 8(b) and sets the broadcasting timing for the beacon signal to the second subframe. In FIG. 8(d), the road-to-vehicle transmission period is set from the first subframe to the N-th subframe. Therefore, the receipt frequency is further increased as compared with FIG. 8(c). For this reason, the determining unit 114 decreases the broadcasting frequency more greatly than in FIG. 8(c) and the broadcasting timing for the beacon signal is not set. In the case in which the beacon signal is broadcasted only once for two frames as in the broadcasting frequency of “B3” in FIG. 7, FIGS. 8(c) and 8(d) are repeated every frame. FIG. 6 will be referenced again.

The broadcasting unit 116 generates the beacon signal. When the timing determined in the determining unit 114 arrives, the broadcasting unit 116 executes a carrier sense in the carrier sense unit 94 and broadcasts the beacon signal through the modem unit 134 and the RF unit 132 if the broadcasting can be carried out. The communicating unit 118 executes a connection processing to the terminal apparatus 14 receiving the beacon signal and executes a communication with the terminal apparatus 14 permitting the connection. Herein, the communication corresponds to the IP communication. FIG. 5(c) shows a format of a packet signal in the IP communication. The format of the packet signal shown in FIG. 5(c) is similar to the format of the packet signal shown in FIG. 5(a). However, the IP header is disposed in place of the message header. The packet signal of the IP communication may have a variable length and the MAC header includes information about the length of the packet signal. The control unit 138 controls an operation timing for the IP communicating base station apparatus 16.

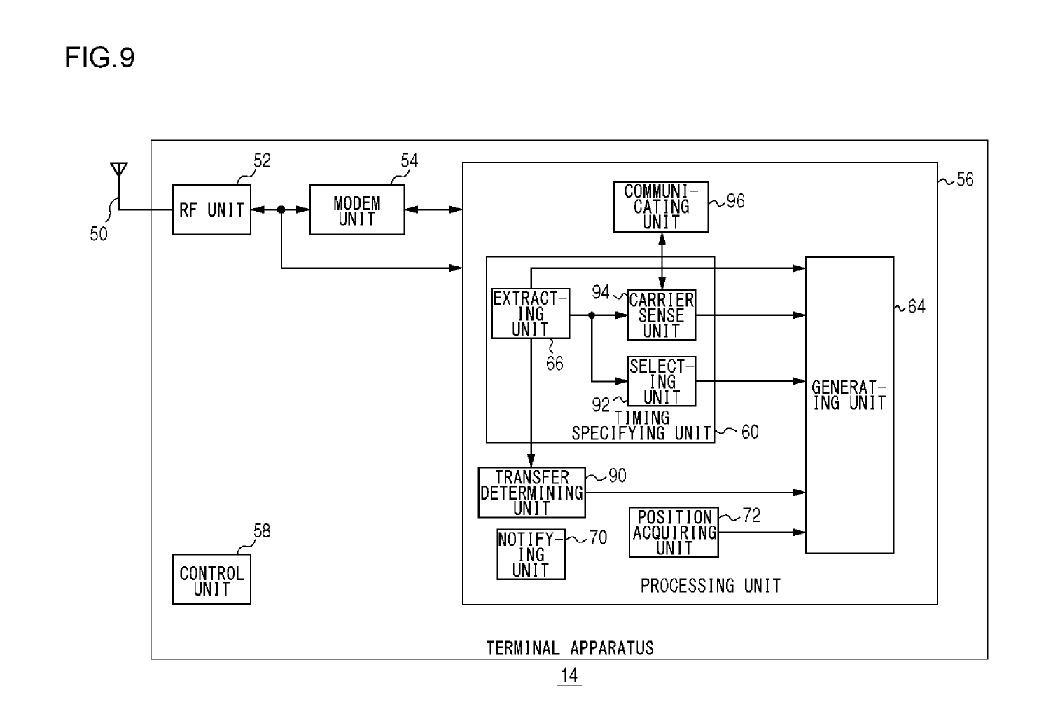

FIG. 9 shows a structure of the terminal apparatus 14 mounted on the vehicle 12. The terminal apparatus 14 includes an antenna 50, an RF unit 52, a modem unit 54, a processing unit 56, and a control unit 58. The processing unit 56 includes a generating unit 64, a timing specifying unit 60, a transfer determining unit 90, a notifying unit 70, a position acquiring unit 72, and a communicating unit 96. Moreover, the timing specifying unit 60 includes an extracting unit 66, a selecting unit 92 and the carrier sense unit 94. The antenna 50, the RF unit 52 and the modem unit 54 execute the same processing as those of the antenna 20, the RF unit 22 and the modem unit 24 in FIG. 2. For this reason, a difference will be mainly described.

The modem unit 54 and the processing unit 56 receive a packet signal from the other terminal apparatus 14 or the base station apparatus 10 which is not shown. As described above, the modem unit 54 and the processing unit 56 receive the packet signal from the base station apparatus 10 for the road-to-vehicle transmission period, and receive the packet signal from the other terminal apparatus 14 for the priority period or the general period. Furthermore, the modem unit 54 and the processing unit 56 receive the beacon signal from the IP communicating base station apparatus 16 or receive the IP communicating packet signal from the IP communicating base station apparatus 16 or the other terminal apparatus 14 in some case.

The extracting unit 66 specifies a timing for a subframe in which the road-to-vehicle transmission period is disposed in the case in which the demodulation result obtained from the modem unit 54 is the packet signal sent from the base station apparatus 10 which is not shown. Moreover, the extracting unit 66 generates a frame based on the timing for the subframe, and the contents of the basic part in the message header of the packet signal, more specifically, the contents of the RSU transmission period length. It is sufficient that the frame is generated in the same manner as in the frame defining unit 40 described above. Therefore, description will be omitted. As a result, the extracting unit 66 generates a frame which is synchronized with the frame formed in the base station apparatus 10.

The extracting unit 66 measures the received power of the packet signal sent from the base station apparatus 10. The extracting unit 66 estimates the presence in the first area 210, the presence in the second area 212 or the presence in the area outside the second area 214 based on the received power thus measured. For example, the extracting unit 66 stores an area determining threshold. If the received power is greater than the area determining threshold, the extracting unit 66 determines the presence in the first area 210. If the received power is equal to or smaller than the area determining threshold, the extracting unit 66 determines the presence in the second area 212. In the case in which the packet signal is not received from the base station apparatus 10, the extracting unit 66 determines the presence in the area outside the second area 214. The extracting unit 66 may use an error rate in place of the received power and may use a combination of the received power and the error rate.

The extracting unit 66 determines, as the transmission period, the priority period, the general period or a timing which is not related to the structure of the frame based on the estimation result. More specifically, when estimating the presence in the area outside the second area 214, the extracting unit 66 selects the timing which is not related to the structure of the frame. When estimating the presence in the second area 212, the extracting unit 66 selects the general period. When estimating the presence in the first area 210, the extracting unit 66 selects the priority period. When selecting the priority period, the extracting unit 66 outputs, to the selecting unit 92, the detection result included in the data payload of the control packet signal. When selecting the general period, the extracting unit 66 outputs, to the carrier sense unit 94, the timings for the frame and the subframe and the information about the inter-vehicle transmission period. When selecting the timing which is not related to the structure of the frame, the extracting unit 66 notifies an instruction for executing the carrier sense to the carrier sense unit 94.

The selecting unit 92 accepts the detection result from the extracting unit 66. As described above, the detection result indicates either of an empty slot, a used slot or a collision slot to each of the slots included in the priority period. The selecting unit 92 selects any of the empty slots. In the case in which the slot has already been selected, the selecting unit 92 continuously selects the same slot if the slot is the used slot. On the other hand, in the case in which the slot has already been selected, the selecting unit 92 newly selects the empty slot if the slot is the collision slot. The selecting unit 92 notifies information about the selected slot as a transmission timing to the generating unit 64.

The carrier sense unit 94 accepts, from the extracting unit 66, the timing for the frame and the subframe and information about the inter-vehicle transmission period. The carrier sense unit 94 executes the carrier sense, thereby measuring an interference power for the general period. Moreover, the carrier sense unit 94 determines a transmission timing for the general period based on the interference power. More specifically, the carrier sense unit 94 prestores a predetermined threshold and compares the interference power with the threshold. If the interference power is smaller than the threshold, the carrier sense unit 94 determines the transmission timing. In the case in which an instruction for executing the carrier sense is notified from the extracting unit 66, the carrier sense unit 94 executes the CSMA, thereby determining the transmission timing without taking the structure of the frame into consideration. The carrier sense unit 94 notifies the generating unit 64 of the transmission timing which is determined.

The position acquiring unit 72 includes a GPS receiver, a gyroscope, a vehicle speed sensor which are not shown, and the like, and acquires a presence position, an advancing direction, a moving speed and the like of the vehicle 12, that is, the vehicle 12 provided with the terminal apparatus 14 (which will be hereinafter referred to as “position information”) based on data supplied from them. The presence position is indicated by a latitude and a longitude. It is sufficient that these are acquired by using the well-known technique. Therefore, description will be omitted. The position acquiring unit 72 outputs the position information to the generating unit 64.

The transfer determining unit 90 controls a transfer of the message header. The transfer determining unit 90 extracts the message header from the packet signal. In the case in which the packet signal is directly transmitted from the base station apparatus 10, the recycling number is set to be “0”. In the case in which the packet signal is transmitted from the other terminal apparatus 14, the recycling number is set to be a value of “one or more”. The transfer determining unit 90 selects the message header to be transferred from the message header thus extracted. Herein, the message header having the smallest recycling number is selected, for example. Moreover, the transfer determining unit 90 may generate a new message header by synthesizing the contents included in the message headers. The transfer determining unit 90 outputs a message header to be selected to the generating unit 64. In that case, the transfer determining unit 90 increases the recycling number by “1”.

The generating unit 64 accepts the position information from the position acquiring unit 72 and accepts the message header from the transfer determining unit 90. The generating unit 64 uses the MAC frame shown in FIGS. 5(a) and 5(b) to store the position information in the data payload. The generating unit 64 generates the packet signal included in the MAC frame, and furthermore, broadcasts the generated packet signal through the modem unit 54, the RF unit 52 and the antenna 50 in a transmission timing determined in the selecting unit 92 or the carrier sense unit 94. The transmission timing is included in the inter-vehicle transmission period.

The notifying unit 70 acquires the packet signal from the base station apparatus 10 (not shown) for the road-to-vehicle transmission period, and furthermore, acquires the packet signal from the other terminal apparatus 14 (not shown) for the inter-vehicle transmission period. The notifying unit 70 notifies a driver of the approach of the other vehicle 12 (not shown) or the like through a monitor or a speaker depending on the contents of the data stored in the packet signal as a processing for the packet signal which is acquired.

In order to execute the IP communication, the communicating unit 96 receives the beacon signal through the RF unit 52 and modem unit 54. The communicating unit 96 specifies the IP communicating base station apparatus 16 to be a communicating target based on the beacon signal. The communicating unit 96 transmits the packet signal including a connecting request to the IP communicating base station apparatus 16 which is specified. Then, the communicating unit 96 executes the IP communication with the IP communicating base station apparatus 16. This corresponds to the receipt or transmission of the IP communicating packet signal shown in FIG. 5(c). It is sufficient that the well-known technique is used for a procedure for executing the IP communication. Therefore, description will be omitted. The control unit 58 controls the operation of the whole terminal apparatus 14.

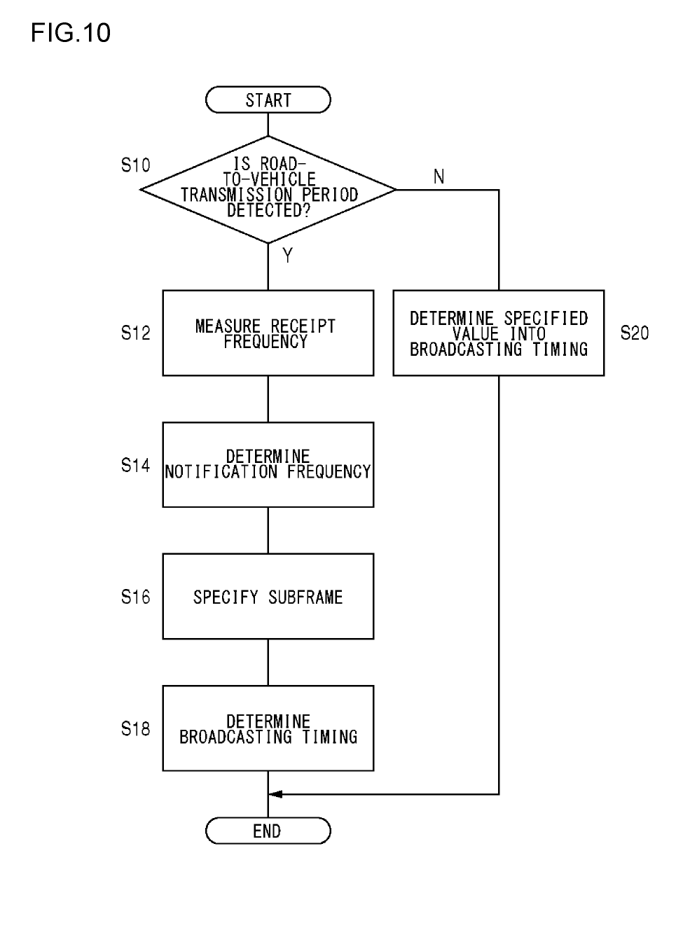

Description will be given to an operation of the communication system 100 having the structure described above. FIG. 10 is a flow chart showing a procedure for determining a broadcasting timing by the IP communicating base station apparatus 16. If the acquiring unit 110 detects a road-to-vehicle transmission period (Y in S10), the measuring unit 112 measures a receipt frequency (S12). The determining unit 114 determines a broadcasting frequency based on the receipt frequency (S14). The acquiring unit 110 specifies a subframe other than a subframe to which the road-to-vehicle transmission period is set (S16). The determining unit 114 determines the broadcasting timing (S18). On the other hand, if the acquiring unit 110 does not detect the road-to-vehicle transmission period (N in S10), the determining unit 114 determines a specified value as the broadcasting timing (S20).

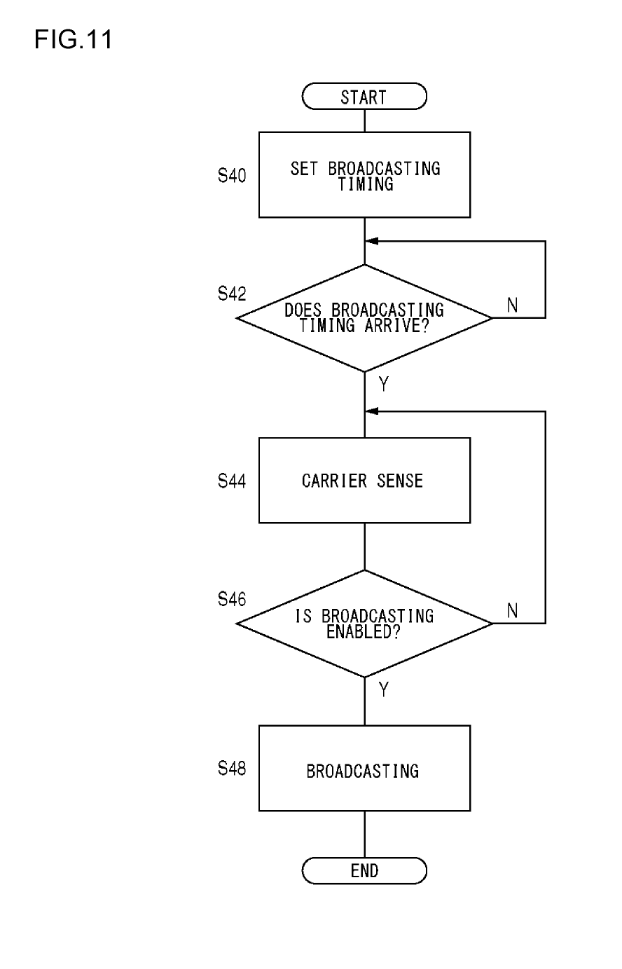

FIG. 11 is a flow chart showing a broadcasting procedure for a beacon signal by the IP communicating base station apparatus 16. The broadcasting unit 116 sets a broadcasting timing (S40). If the broadcasting timing does not arrive (N in S42), the processing stands by. If the broadcasting timing arrives (Y in S42), the broadcasting unit 116 executes a carrier sense (S44). If the broadcasting is not enabled (N in S46), the processing returns to the Step 44. If the broadcasting is enabled (Y in S46), the broadcasting unit 116 broadcasts the beacon signal (S48).

Next, a modified example according to the present invention will be described. In the same manner as in the embodiment, the modified example also relates to a communication system to be used in an ITS. In the embodiment, the base station apparatus 10 for controlling the inter-vehicle communication and the IP communicating base station apparatus 16 for executing the IP communication are provided separately. In the modified example, there is provided a base station apparatus 10 having a function for controlling an inter-vehicle communication and a function for executing an IP communication. A communication system 100 according to the modified example is of the same type as that in FIG. 1 and a terminal apparatus 14 is of the same type as that in FIG. 9. Herein, a difference will be mainly described.

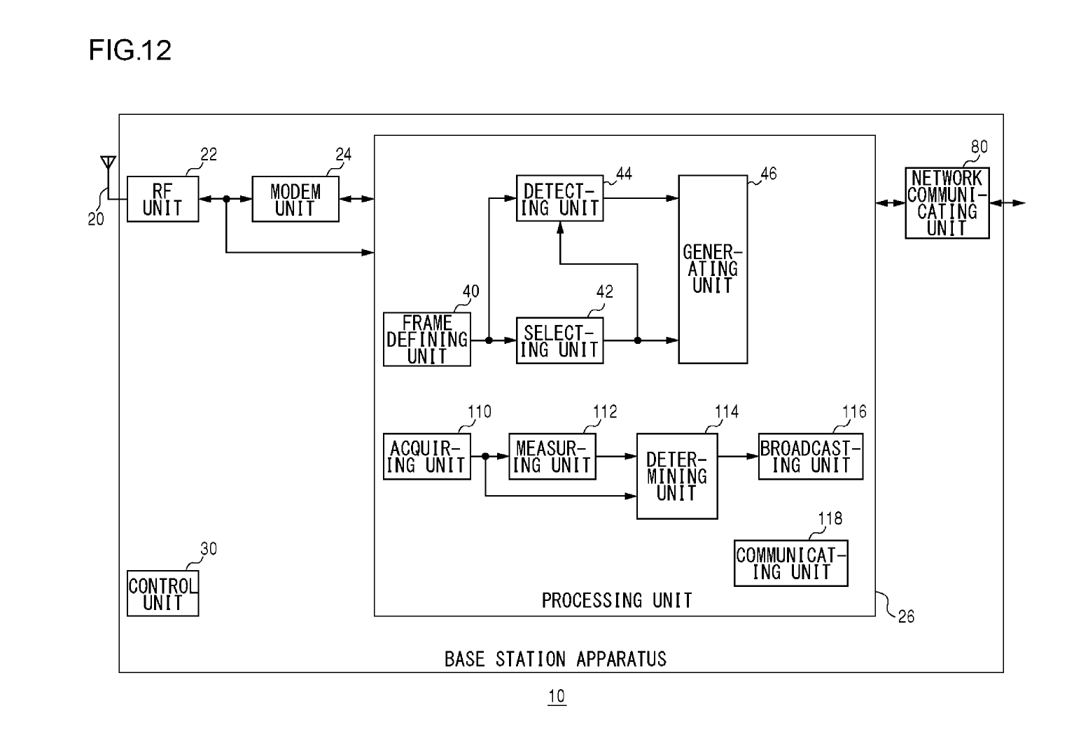

FIG. 12 shows a structure of the base station apparatus 10 according to the modified example of the present invention. The base station apparatus 10 has a structure obtained by combining the structure shown in FIG. 2 and the structure shown in FIG. 6. Herein, the description of the base station apparatus 10 will be omitted.

Next, another modified example according to the present invention will be described. In the another modified example according to the present invention, an IP communicating base station apparatus and a terminal apparatus estimate a utilization rate of an inter-vehicle communication and also estimates a free time rate of a resource. Moreover, an IP communicating base station apparatus and a terminal apparatus regulates an easiness of a transmission for an IP communicating packet signal based on the utilization rate and the free time rate. A communication system 100 according to the another modified example is of the same type as that in FIG. 1 and a base station apparatus 10 is of the same type as that in FIG. 2. Herein, a difference will be mainly described.

The IP communicating base station apparatus 16 in FIG. 1 uses a frequency band identical with that of the base station apparatus 10, and executes an IP communication with a terminal apparatus. As a result, the terminal apparatus accesses the Internet through the IP communicating base station apparatus 16 and a network 202. The inter-vehicle communication and the road-to-vehicle communication are broadcasted. However, the IP communication of the IP communicating base station apparatus 16 and the terminal apparatus is carried out through a unicast, and CSMA/CA is executed in the IP communication. As described above, the IP communication is required not to prevent the inter-vehicle communication or the like. In order to take a countermeasure, the IP communicating base station apparatus 16 and the terminal apparatus estimates a utilization rate of a resource and a free time rate of the resource through the inter-vehicle communication, and regulates IFS (Inter Frame Space) in the CSMA/CA depending on them. The details will be described later.

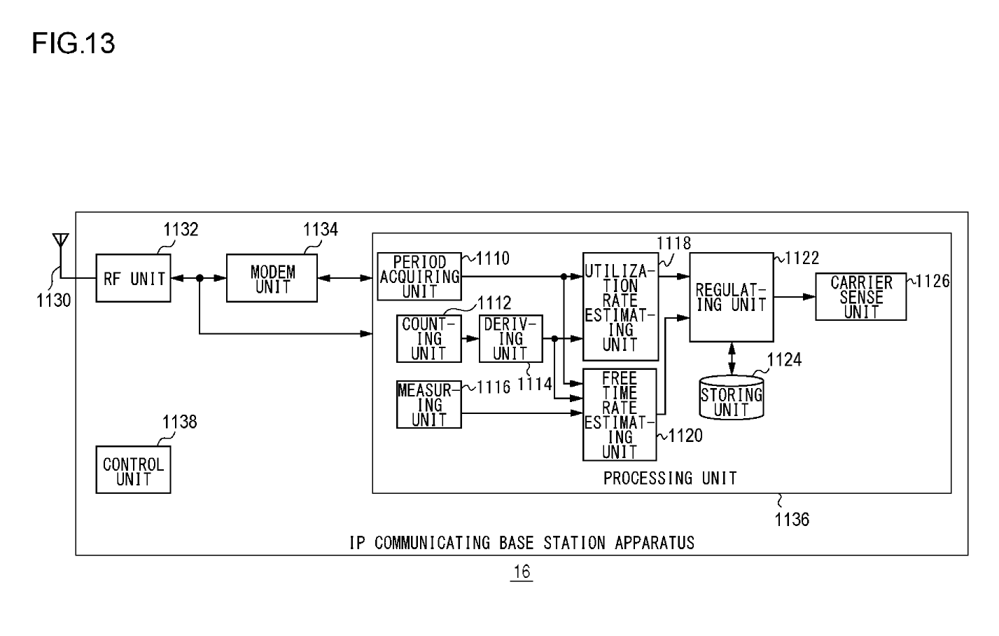

FIG. 13 shows a structure of the IP communicating base station apparatus 16. The IP communicating base station apparatus 16 includes an antenna 1130, an RF unit 1132, a modem unit 1134, a processing unit 1136 and a control unit 1138. Moreover, the processing unit 1136 includes a period acquiring unit 1110, a counting unit 1112, a deriving unit 1114, a measuring unit 1116, a utilization rate estimating unit 1118, a free time rate estimating unit 1120, a regulating unit 1122, a storing unit 1124, and a carrier sense unit 1126. The antenna 1130, the RF unit 1132 and the modem unit 1134 executes the same processings as those of the antenna 20, the RF unit 22 and the modem unit 24 in FIG. 2. Therefore, a difference will be mainly described.

The period acquiring unit 1110 acquires a control packet signal or an RSU packet signal transmitted from the base station apparatus 10 (not shown) through the RF unit 1132 and the modem unit 1134 for a road-to-vehicle transmission period. The period acquiring unit 1110 acquires information about an RSU transmission period length included in message headers of the packet signals. In the case in which the RSU transmission period length for each of the base station apparatuses 10 is acquired, the period acquiring unit 1110 adds them. By the processing, the period acquiring unit 1110 acquires a length “a” of the road-to-vehicle transmission period in a frame. The period acquiring unit 1110 outputs the length “a” of the road-to-vehicle transmission period to the utilization rate estimating unit 1118 and the free time rate estimating unit 1120.

The counting unit 1112 receives a packet signal for an inter-vehicle communication and counts the number of the received packet signals through the RF unit 1132 and the modem unit 1134 for a priority period and a general period. These packet signals are broadcasted from a terminal apparatus which is not shown. It is assumed that the length of the packet signal is constant. The counting unit 1112 derives the number of the packet signals per frame. Through a division of the number of the received packets signals by the number of frames, the counting unit 1112 may derive an average value as the number of the packet signals per frame. The counting unit 1112 outputs the number of the packet signals per frame to the deriving unit 1114.

The deriving unit 1114 accepts the number of the packets signals per frame from the counting unit 1112. Moreover, the deriving unit 1114 stores a period for the packet signal broadcasted from the terminal apparatus. The deriving unit 1114 multiplies the number of the packet signals by the period for the packet signal, thereby deriving a period “b” in which the packet signal for the inter-vehicle communication is broadcasted for the inter-vehicle transmission period. The deriving unit 1114 outputs the period “b” to the utilization rate estimating unit 1118 and the free time rate estimating unit 1120.

The measuring unit 1116 receives the IP communicating packet signal through the RF unit 1132 and the modem unit 1134. The packet signal is transmitted from the terminal apparatus (not shown) or the other IP communicating base station apparatus 16. FIG. 5(c) shows a format of the IP communicating packet signal. Although the format of the packet signal shown in FIG. 5(c) is similar to the format of the packet signal shown in FIG. 5(a), an IP header is disposed in place of the message header. The IP communicating packet signal has a variable length and the MAC header includes information about the length of the packet signal. FIG. 13 will be referenced again. The measuring unit 1116 recognizes the length of the packet signal through the acquisition of the information. In the case in which a plurality of IP communicating packet signals is received in the frame, the measuring unit 1116 measures them. By the processing, the measuring unit 1116 measures a period “c” for which the IP communicating packet signal is transmitted in the frame. In the case in which the IP communicating base station apparatus 16 transmits the IP communicating packet signal, this is also set to be an addition target. The measuring unit 1116 outputs the period “c” to the free time rate estimating unit 1120.

The utilization rate estimating unit 1118 accepts the length “a” and the period “b” from the period acquiring unit 1110 and the counting unit 1112, respectively. The utilization rate estimating unit 1118 estimates a frame utilization rate r1 based on the length “a” and the period “b”. The frame utilization rate r1 is derived as follows:

r1=(a+b)/T*100

wherein T represents a frame period. The utilization rate estimating unit 1118 outputs the frame utilization rate r1 to the regulating unit 1122.

The free time rate estimating unit 1120 accepts the length “a”, the period “b” and the period “c” from the period acquiring unit 1110, the counting unit 1112 and the measuring unit 1116, respectively. The free time rate estimating unit 1120 integrates the length “a”, the period “b” and the period “c” and then estimate a frame free time rate r2 based on an integrated value and the frame period T. The frame free time rate r2 is derived as follows.

r2=(T−(a+b+c))/T*100

The free time rate estimating unit 1120 outputs the frame free time rate r2 to the regulating unit 1122.

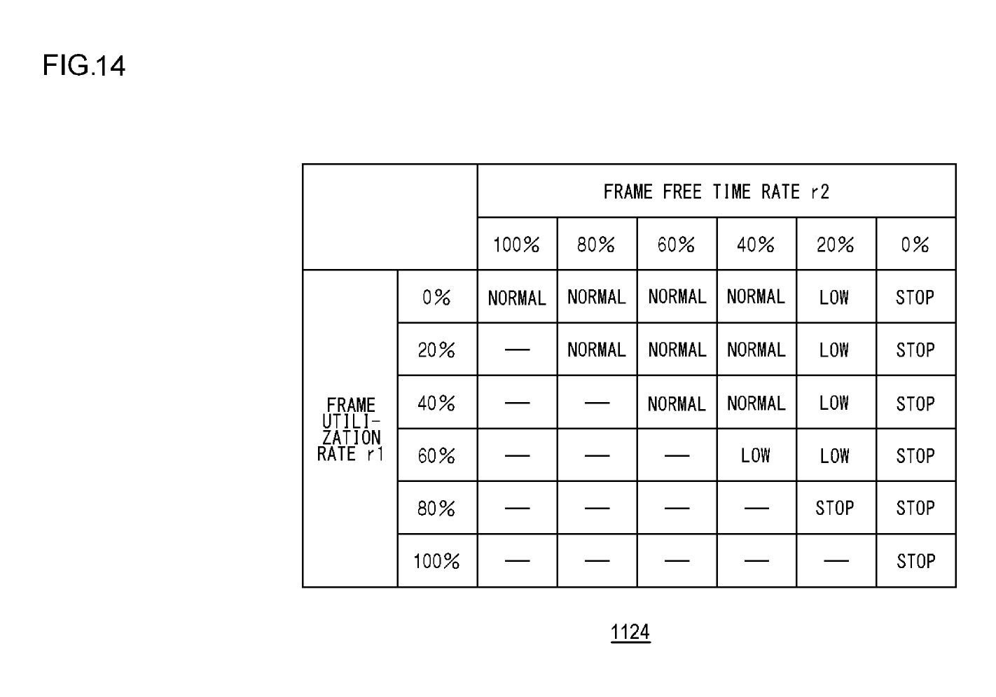

The regulating unit 1122 accepts the frame utilization rate r1 from the utilization rate estimating unit 1118, and furthermore, accepts the frame free time rate r2 from the free time rate estimating unit 1120. The regulating unit 1122 determines IFS in the execution of the carrier sense based on the frame utilization rate r1 and the frame free time rate r2 by referring to the table stored in the storing unit 1124. The storing unit 1124 prestores the table. FIG. 14 shows a data structure of the table stored in the storing unit 1124. In the table, a priority of a transmission is indicated for a combination of the frame utilization rate r1 and the frame free time rate r2. Although a three-stage priority of “normal”, “low” and “stop” is indicated as the priority of the transmission, a priority having more stages may be defined.

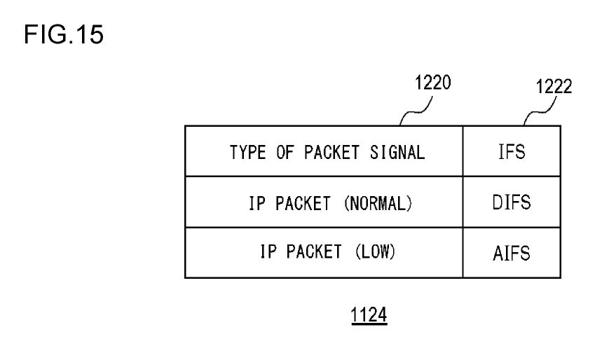

FIG. 15 shows a data structure of another table stored in the storing unit 1124. A packet signal type column 1220 and an IFS column 1222 are shown. The priorities of “normal” and “low” are shown in the packet signal type column 1220 and the IFS corresponding to each priority is shown in the IFS column 1222. Herein, “DIFS (Distributed Interframe Space)” and “AIFS (Arbitration Inter Frame Space)” are defined, and AIFS>DIFS is assumed. When the priority is decreased, the IFS is increased so that the packet signal is difficult to be transmitted. In other words, there is defined such a priority that the packet signal is more difficult to be transmitted as the frame free time rate r2 is reduced and the frame utilization rate r1 is increased. FIG. 13 will be referenced again. Thus, the regulating unit 1122 regulates the easiness of the transmission of the IP communicating packet signal based on the frame free time rate r2 and the frame utilization rate r1. The regulating unit 1122 outputs the determined IFS value to the carrier sense unit 1126.

The carrier sense unit 1126 executes the carrier sense between the IFS accepted from the regulating unit 1122 and a contention window. As a result of the carrier sense, if a use of a radio wave is not detected, the processing unit 1136 transmits the IP communicating packet signal through the modem unit 1134 and the RF unit 1132. The control unit 1138 controls an operation timing of the IP communicating base station apparatus 16.

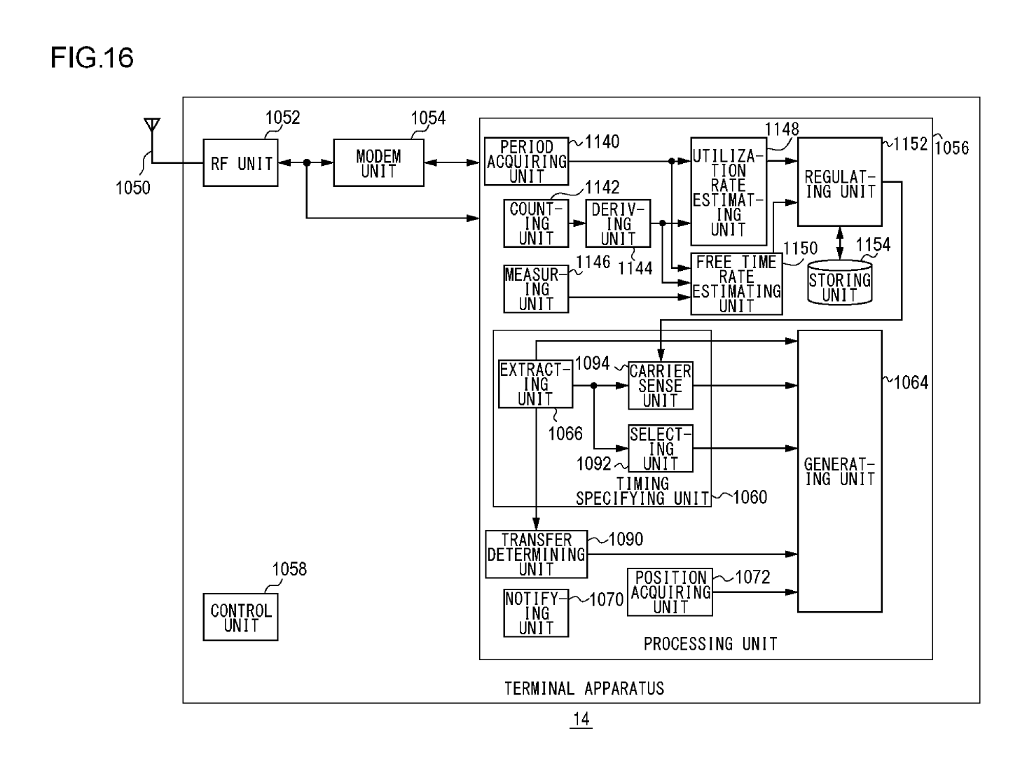

FIG. 16 shows a structure of the terminal apparatus 14 mounted on the vehicle 12. The terminal apparatus 14 includes an antenna 1050, an RF unit 1052, a modem unit 1054, a processing unit 1056, and a control unit 1058. The processing unit 1056 includes a generating unit 1064, a timing specifying unit 1060, a transfer determining unit 1090, a notifying unit 1070, a position acquiring unit 1072, a period acquiring unit 1140, a counting unit 1142, a deriving unit 1144, a measuring unit 1146, a utilization rate estimating unit 1148, a free time rate estimating unit 1150, a regulating unit 1152, and a storing unit 1154. Moreover, the timing specifying unit 1060 includes an extracting unit 1066, a selecting unit 1092 and a carrier sense unit 1094. The antenna 1050, the RF unit 1052 and the modem unit 1054 execute the same processings as those of the antenna 20, the RF unit 22 and the modem unit 24 in FIG. 2. Moreover, portions from the period acquiring unit 1140 to the storing unit 1154 execute the same processings as those of the portions from the period acquiring unit 1110 to the storing unit 1124 in FIG. 13. Therefore, a difference will be mainly described.

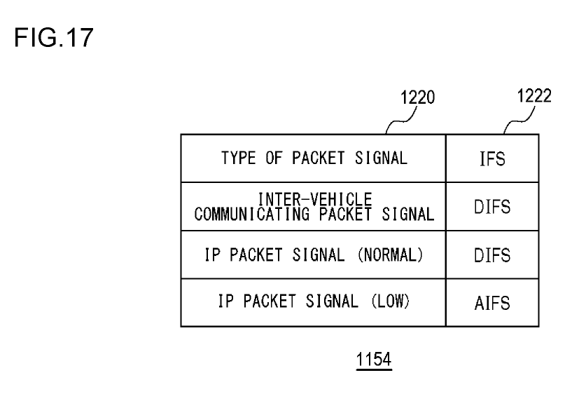

FIG. 17 shows a data structure of the table stored in the storing unit 1154. Although the table is shown in the same manner as the table of FIG. 15, an inter-vehicle communicating packet signal is also included as the type of the packet signal. In other words, a high priority is defined for the inter-vehicle communicating packet signal to be broadcasted for the general period. FIG. 16 will be referenced again. The modem unit 1054 and the processing unit 1056 receive the packet signal from the other terminal apparatus 14 or the base station apparatus 10 which is not shown. As described above, the modem unit 1054 and the processing unit 1056 receive the packet signal from the base station apparatus 10 for the road-to-vehicle transmission period, and receives the packet signal from the other terminal apparatus 14 for the priority period and the general period. Furthermore, the modem unit 1054 and the processing unit 1056 receive the IP communicating packet signal from the IP communicating base station apparatus 16 the other terminal apparatus 14 in some cases.

The extracting unit 1066 specifies a timing for a subframe in which the road-to-vehicle transmission period is disposed in the case in which the demodulation result obtained from the modem unit 1054 is the packet signal sent from the base station apparatus 10 which is not shown. Moreover, the extracting unit 1066 generates a frame based on the timing for the subframe, and the contents of the basic part in the message header of the packet signal, more specifically, the contents of the RSU transmission period length. It is sufficient that the frame is generated in the same manner as in the frame defining unit 40. Therefore, description will be omitted. As a result, the extracting unit 1066 generates a frame which is synchronized with the frame formed in the base station apparatus 10.

The extracting unit 1066 measures the received power of the packet signal sent from the base station apparatus 10. The extracting unit 1066 estimates the presence in the first area 210, the presence in the second area 212 or presence in the area outside the second area 214 based on the received power thus measured. For example, the extracting unit 1066 stores an area determining threshold. If the received power is greater than the area determining threshold, the extracting unit 1066 determines the presence in the first area 210. If the received power is equal to or smaller than the area determining threshold, the extracting unit 1066 determines the presence in the second area 212. In the case in which the packet signal is not received from the base station apparatus 10, the extracting unit 1066 determines the presence in the area outside the second area 212. The extracting unit 1066 may use an error rate in place of the received power and may use a combination of the received power and the error rate.

The extracting unit 1066 determines, as the transmission period, the priority period, the general period or a timing which is not related to the structure of the frame based on the estimation result. More specifically, when estimating the presence in the area outside the second area 214, the extracting unit 1066 selects the timing which is not related to the structure of the frame. When estimating the presence in the second area 212, the extracting unit 1066 selects the general period. When estimating the presence in the first area 210, the extracting unit 1066 selects the priority period. When selecting the priority period, the extracting unit 1066 outputs, to the selecting unit 1092, the detection result included in the data payload of the control packet signal. When selecting the general period, the extracting unit 1066 outputs, to the carrier sense unit 1094, the timings for the frame and the subframe and the information about the inter-vehicle transmission period. When selecting the timing which is not related to the structure of the frame, the extracting unit 1066 notifies an instruction for executing the carrier sense to the carrier sense unit 1094.

The selecting unit 1092 accepts the detection result from the extracting unit 1066. As described above, the detection result indicates either of an empty slot, a used slot or a collision slot to each of the slots included in the priority period. The selecting unit 1092 selects any of the empty slots. In the case in which the slot has already been selected, the selecting unit 1092 continuously selects the same slot if the slot is the used slot. On the other hand, in the case in which the slot has already been selected, the selecting unit 1092 newly selects the empty slot if the slot is the collision slot. The selecting unit 1092 notifies information about the selected slot as a transmission timing to the generating unit 1064.

The carrier sense unit 1094 accepts, from the extracting unit 1066, the timing for the frame and the subframe and information about the inter-vehicle transmission period. The carrier sense unit 1094 executes the carrier sense, thereby measuring an interference power for the general period. Moreover, the carrier sense unit 1094 determines a transmission timing for the general period based on the interference power. More specifically, the carrier sense unit 1094 prestores a predetermined threshold and compares the interference power with the threshold. If the interference power is smaller than the threshold, the carrier sense unit 1094 determines the transmission timing. In the case in which an instruction for executing the carrier sense is notified from the extracting unit 1066, the carrier sense unit 1094 executes the CSMA, thereby determining the transmission timing without taking the structure of the frame into consideration. The carrier sense unit 1094 notifies the generating unit 1064 of the transmission timing which is determined.

The position acquiring unit 1072 includes a GPS receiver, a gyroscope, a vehicle speed sensor which are not shown, and the like, and acquires a presence position, an advancing direction, a moving speed and the like of the vehicle 12, that is, the vehicle 12 provided with the terminal apparatus 14 (which will be hereinafter referred to as “position information”) based on data supplied from them. The presence position is indicated by a latitude and a longitude. It is sufficient that these are acquired by using the well-known technique. Therefore, description will be omitted. The position acquiring unit 1072 outputs the position information to the generating unit 1064.

The transfer determining unit 1090 controls a transfer of the message header. The transfer determining unit 1090 extracts the message header from the packet signal. In the case in which the packet signal is directly transmitted from the base station apparatus 10, the recycling number is set to be “0”. In the case in which the packet signal is transmitted from the other terminal apparatus 14, the recycling number is set to be a value of “one or more”. The transfer determining unit 1090 selects the message header to be transferred from the message header thus extracted. Herein, the message header having the smallest recycling number is selected, for example. Moreover, the transfer determining unit 1090 may generate a new message header by synthesizing the contents included in the message headers. The transfer determining unit 1090 outputs a message header to be selected to the generating unit 1064. In that case, the transfer determining unit 1090 increases the recycling number by “1”.

The generating unit 1064 accepts the position information from the position acquiring unit 1072 and accepts the message header from the transfer determining unit 1090. The generating unit 1064 uses the MAC frame shown in FIGS. 5(a) and 5(b) to store the position information in the data payload. The generating unit 1064 generates the packet signal included in the MAC frame, and furthermore, broadcasts the generated packet signal through the modem unit 1054, the RF unit 1052 and the antenna 1050 in a transmission timing determined in the selecting unit 1092 or the carrier sense unit 1094. The transmission timing is included in the inter-vehicle transmission period.

The notifying unit 1070 acquires the packet signal from the base station apparatus 10 (not shown) for the road-to-vehicle transmission period, and furthermore, acquires the packet signal from the other terminal apparatus 14 (not shown) for the inter-vehicle transmission period. The notifying unit 1070 notifies a driver of the approach of the other vehicle 12 (not shown) or the like through a monitor or a speaker depending on the contents of the data stored in the packet signal as a processing for the packet signal which is acquired. The control unit 1058 controls the operation of the whole terminal apparatus 14.

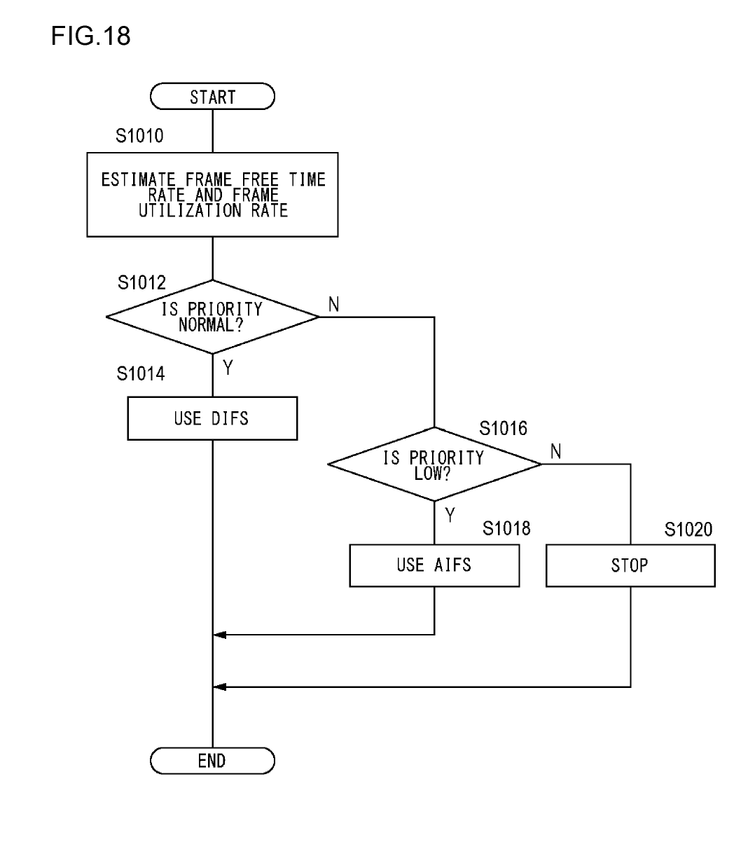

Description will be given to an operation of the communication system 100 having the structure described above. FIG. 18 is a flow chart showing a procedure for controlling a transmission timing in the terminal apparatus 14. The IP communicating base station apparatus 16 also executes the same processing. The free time rate estimating unit 1150 and the utilization rate estimating unit 1148 estimate a frame free time rate and a frame utilization rate (S1010). If a priority is normal (Y in S1012), the regulating unit 1152 uses DIFS (S1014). If the priority is not normal (N in S1012) and is low (Y in S1016), the regulating unit 1152 uses AIFS (S1018). If the priority is not low (N in S1016), that is, “stop” is set, the regulating unit 1152 determines the stop (S1020).

Next, a further modified example according to the present invention will be described. In the same manner as in the another modified example, the further modified example also relates to a communication system to be used in ITS. In the another modified example, the base station apparatus 10 for controlling an inter-vehicle communication and the IP communicating base station apparatus 16 for executing an IP communication are provided separately from each other. In the further modified example, there is provided the base station apparatus 10 having a function for controlling the inter-vehicle communication and a function for executing the IP communication. A communication system 100 according to the further modified example is of the same type as that in FIG. 1, and a terminal apparatus 14 is of the same type as that in FIG. 16. Herein, a difference will be mainly described.

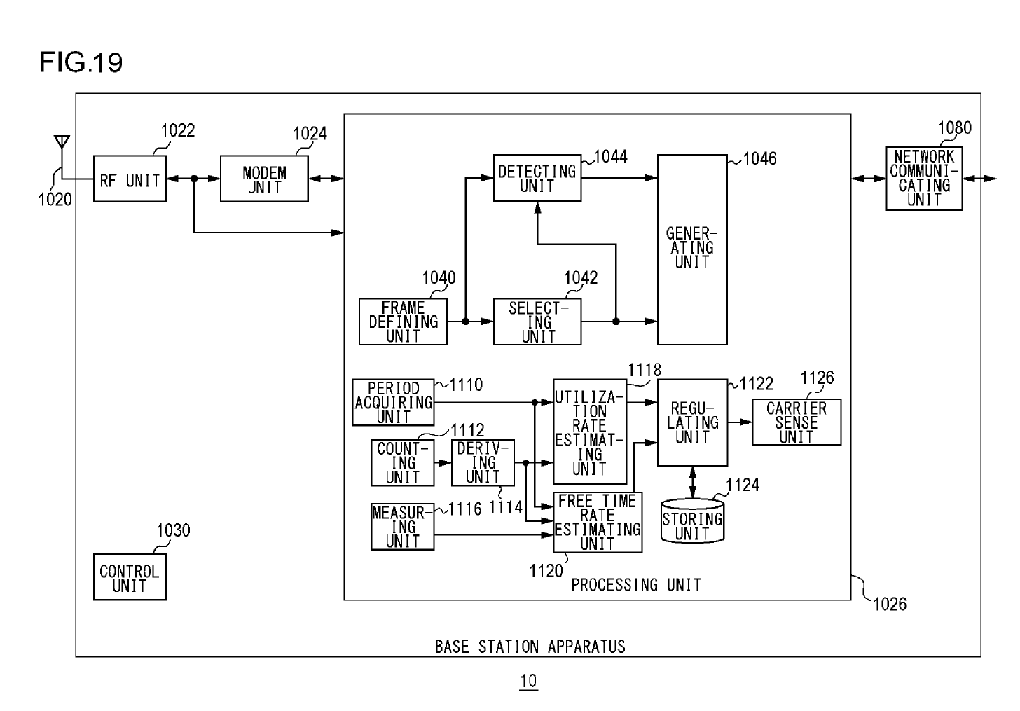

FIG. 19 shows a structure of the base station apparatus 10 according to the further modified example of the present invention. The base station apparatus 10 has a structure obtained by combining the structure show in FIG. 2 and the structure shown in FIG. 13. Herein, description of the base station apparatus 10 will be omitted. An antenna 1020, an RF unit 1022, a modem unit 1024, a processing unit 1026, a control unit 1030, a frame defining unit 1040, a selecting unit 1042, a detecting unit 1044, a generating unit 1046 and a network communicating unit 1080 in FIG. 19 correspond to the antenna 20, the RF unit 22, the modem unit 24, the processing unit 26, the control unit 30, the frame defining unit 40, the selecting unit 42, the detecting unit 44, the generating unit 46 and the network communicating unit 80 in FIG. 2, respectively.

According to the embodiment of the present invention, when the control packet signal or the RSU packet signal is acquired, the receipt frequency is measured. Therefore, it is possible to estimate a traffic amount of the inter-vehicle communication. For the measurement of the receipt frequency, moreover, the control packet signal or the RSU packet signal is used. Therefore, it is possible to easily estimate the traffic amount of the inter-vehicle communication. Furthermore, the broadcasting frequency of the beacon signal is regulated depending on the traffic amount of the inter-vehicle communication. Consequently, it is possible to reduce an influence on the inter-vehicle communication. In addition, since the broadcasting frequency of the beacon signal is regulated, it is possible to regulate the traffic amount of the IP communication. Moreover, the traffic amount of the IP communication is regulated. Therefore, it is possible to reduce a mutual influence between communications for a plurality of objects. As the receipt frequency is increased, the broadcasting frequency is decreased. Therefore, it is possible to reduce a collision probability of the packet signal and the beacon signal in the inter-vehicle communication.

Moreover, the broadcasting frequency is increased as the receipt frequency is decreased. Therefore, it is possible to increase the traffic amount of the IP communication. Furthermore, the traffic amount of the IP communication is increased. Therefore, it is possible to enhance the utilization efficiency of a frequency. In addition, the broadcasting timing of the beacon signal is set to the subframe other than the subframe to which the road-to-vehicle transmission period is set. Therefore, it is possible to reduce the collision probability of the beacon signal with the control packet signal or the RSU packet signal. Since the broadcasting frequency is controlled on the subframe unit, moreover, the broadcasting frequency can be regulated in detail. Since the broadcasting frequency is controlled on the frame unit, furthermore, the control can easily be carried out.

In order to distinguish the first area from the second area, the received power is used. Therefore, a range in which a propagation loss is included to a certain degree can be defined into the first area. Moreover, the range in which the propagation loss is included to the predetermined degree is defined into the first area. Therefore, the vicinity of a center of an intersection can be used as the first area. Moreover, time division multiplexing through the slot is executed for the priority period. Therefore, it is possible to reduce an error rate. Furthermore, the CSMA/CA is executed for the general period. Therefore, it is possible to flexibly regulate the number of terminals to be provided.

In addition, the frame utilization rate is derived based on the duration of the road-to-vehicle transmission period and the period of the packet signal in the inter-vehicle communication. Therefore, it is possible to derive a rate of the use in the inter-vehicle communication. Moreover, the rate of the use in the inter-vehicle communication is derived. Consequently, it is possible to specify a resource amount to be ensured for the inter-vehicle communication. Moreover, the frame free time rate is derived based on the duration of the road-to-vehicle transmission period, the period of the packet signal of the inter-vehicle communication and the period of the packet signal of the IP communication. Therefore, it is possible to derive a rate of non-use in the communication. In addition, since the rate of the non-use for the communication is derived, it is possible to specify a resource amount which can be used in the IP communication and the inter-vehicle communication. Moreover, the easiness of the transmission of the packet signal in the IP communication is regulated based on the frame free time rate and the frame utilization rate. Consequently, it is possible to reduce the mutual influence in the communications for the objects. As the frame free time rate is decreased and the frame utilization rate is increased, the packet signal in the IP communication is more difficult to be transmitted. Therefore, it is possible to reduce the influence on the inter-vehicle communication. Furthermore, the influence on the inter-vehicle communication is reduced. Therefore, it is possible to implement the IP communication while suppressing a collision of the vehicles.

In order to distinguish the first area from the second area, the received power is used. Therefore, a range in which a propagation loss is included to a certain degree can be defined into the first area. Moreover, the range in which the propagation loss is included to the predetermined degree is defined into the first area. Therefore, the vicinity of a center of an intersection can be used as the first area. Moreover, time division multiplexing through the slot is executed for the priority period. Therefore, it is possible to reduce an error rate. Furthermore, the CSMA/CA is executed for the general period. Therefore, it is possible to flexibly regulate the number of terminals to be provided.

Moreover, a subframe which is being used by the other base station apparatus is specified based on a packet signal received from the terminal apparatus as well as a packet signal received directly from the other base station apparatus. Therefore, it is possible to enhance precision in the specification of the subframe which is being used. Since the precision in the specification of the subframe which is being used is enhanced, moreover, it is possible to reduce the collision probability between the packet signals transmitted from the base station apparatus. Furthermore, the collision probability between the packet signals transmitted from the base station apparatus is reduced. Therefore, the terminal apparatus can accurately recognize control information. Since the control information is accurately recognized, moreover, the road-to-vehicle transmission period can be recognized precisely. Since the road-to-vehicle transmission period is precisely recognized, furthermore, the collision probability of the packet signal can be reduced.

Moreover, the subframe other than the subframe which is being used is utilized preferentially. Therefore, it is possible to reduce a possibility that the packet signal might be transmitted in an overlapping timing with the packet signal sent from the other base station apparatus. In the case in which any subframe is used by the other base station apparatus, furthermore, a subframe having a low received power is selected. Therefore, it is possible to suppress an influence of an interference of the packet signal. Moreover, a received power of a terminal apparatus is used as the received power supplied from the other base station apparatus serving as a transmitting source for control information relayed by the terminal apparatus. Therefore, it is possible to easily carry out a processing for estimating the received power.

The present invention has been described above based on the embodiment. The embodiment is only illustrative and the skilled in the art will understand that various modified examples can be applied to a combination of the components or processes and the modified examples can also be included in the scope of the present invention.

In the embodiment according to the present invention, the acquiring unit 110 acquires the control packet signal or the RSU packet signal from the base station apparatus 10 and the measuring unit 112 measures the receipt frequency based on the control packet signal or the RSU packet signal. However, the present invention is not restricted thereto but the acquiring unit 110 may acquire the packet signal in the inter-terminal communication, for example. In that case, the measuring unit 112 also measures the receipt frequency of the packet signal in the inter-terminal communication which is acquired in the acquiring unit 110. Furthermore, the determining unit 114 also reflects the receipt frequency of the packet signal in the inter-terminal communication which is received in the measuring unit 112, thereby determining the broadcasting timing of the beacon signal. According to the present modified example, the packet signal in the inter-terminal communication is also used in order to determine the broadcasting timing of the beacon signal. Therefore, it is possible to enhance precision in setting of the broadcasting timing.

In the embodiment according to the present invention, the determining unit 114 determines the broadcasting timing of the beacon signal. However, the present invention is not restricted thereto but the determining unit 114 may determine the broadcasting timing of the packet signal other than the beacon signal, for example. The packet signal other than the beacon signal indicates a packet signal including information to be periodically broadcasted by the IP communicating base station apparatus 16. The packet signal includes service information such as a weather report. According to the present modified example, it is possible to regulate the broadcasting frequencies of various packet signals.

What is claimed is:

1. A base station apparatus for communicating with a terminal apparatus, comprising:
a receiving unit configured to receive a packet signal of a first type, wherein the other base station apparatus broadcasts the packet signal of the first type for controlling an inter-terminal communication for a partial period of at least one subframe in a frame multiplexing the subframes in time, and the inter-terminal communication is carried out by the terminal apparatus receiving the packet signal of the first type for a non-broadcasting period of the packet signal of the first type in the frame;
a measuring unit configured to measure a receipt frequency of the packet signal of the first type which is received by the receiving unit;
a determining unit configured to determine a timing to broadcast a packet signal of a second type in order to inform the terminal apparatus of a presence based on the receipt frequency measured by the measuring unit and a receipt timing of the packet signal of the first type which is received by the receiving unit;
a broadcasting unit configured to broadcast the packet signal of the second type in the timing determined by the determining unit; and
a communicating unit configured to execute a communication with the terminal apparatus receiving the packet signal of the second type from the broadcasting unit.

2. The base station apparatus according to claim 1, wherein
the determining unit determines a timing to broadcast the packet signal of the second type to a subframe other than the subframe in which the receiving unit receives the packet signal of the first type.

3. The base station apparatus according to claim 1, wherein
the determining unit determines a timing to broadcast the packet signal of the second type in such a manner that a frequency for broadcasting the packet signal of the second type is decreased when the receipt frequency of the packet signal of the first type measured by the measuring unit is increased.

4. The base station apparatus according to claim 3, wherein
the determining unit controls the frequency for broadcasting the packet signal of the second type on a subframe unit.

5. The base station apparatus according to claim 1, wherein
the receiving unit also receives the packet signal in the inter-terminal communication,
the measuring unit also measures the receipt frequency of the packet signal in the inter-terminal communication which is received by the receiving unit, and
the determining unit also reflects the receipt frequency of the packet signal in the inter-terminal communication which is received by the measuring unit, thereby determining a timing for broadcasting the packet signal of the second type.

6. A terminal apparatus comprising:
an acquiring unit configured to acquire a duration of a first period based on information about the duration of the first period included in a packet signal of a first type broadcasted for the first period in a frame in which the first period for which a base station broadcasts the packet signal of the first type and a second period for which the terminal apparatus broadcasts a packet signal of a second type are multiplexed in time;
a counting unit configured to count the number of the packet signals of the second type having a certain length broadcasted for the second period;
a deriving unit configured to derive a period in which the packet signal of the second type is broadcasted for the second period based on the number of the packet signals of the second type which is counted by the counting unit and a period for the packet signal of the second type;
a measuring unit configured to measure a period in which a packet signal of a third type having a variable length is transmitted; and
an estimating unit configured to integrate the period measured by the measuring unit, the period derived by the deriving unit and the duration of the first period acquired by the acquiring unit and to then estimate a frame free time rate based on an integrated value and a period of the frame, and to estimate a frame utilization rate based on the period derived by the driving unit and the duration of the first period acquired by the acquiring unit.

7. The terminal apparatus according to claim 6, further comprising a regulating unit configured to regulate an easiness of a transmission of the packet signal of the third type based on the frame free time rate and the frame utilization rate which are estimated by the estimating unit.
